(19) United States
(12) Patent Application Publication
(10) Pub. No.: US 2021/0391579 A1
(43) Pub. Date: Dec. 16, 2021

(54) Binder for a Battery Electrode

(71) Applicant: Volt14 Solutions, Hong Kong (CN)

(72) Inventor: Arindam HALDAR, Hong Kong (CN)

(21) Appl. No.: 17/309,125

(22) PCT Filed: Oct. 31, 2019
(86) PCT No.: PCT/CN2019/114649

§ 371 Date: Apr. 27, 2021

Related U.S. Application Data
(60) Provisional application No. 62/754,659, filed on Nov. 2, 2018.

(51) Int. Cl. H01M 4/62; H01M 10/0525; H01M 4/38; H01M 4/48

(52) U.S. Cl. CPC H01M 4/621; H01M 10/0525; H01M 2004/027; H01M 4/386; H01M 4/483; H01M 4/625

(57) ABSTRACT

Provided herein is a binder for a battery electrode, binder compositions, electrodes and batteries comprising the same, and methods of preparation thereof.

### CROSS-REFERENCE TO RELATED APPLICATIONS

This application claims the benefit of priority of U.S. Provisional Application No. 62/754,659, filed on Nov. 2, 2018, the contents of which are hereby incorporated by reference in their entirety for all purposes.

### TECHNICAL FIELD

The present disclosure generally relates to the field of energy storage. More particularly, the present disclosure relates to a binder for a battery electrode and binder compositions, electrodes and energy storage devices comprising the same and methods of preparation thereof.

### BACKGROUND

The lithium-ion battery, first commercialized by Sony in 1991, owes its name to the exchange of the Li⁺ ion between the graphite (LiₓC₆) anode and a layered-oxide (Li₁₋ₓTO₂) cathode, with T being a transition metal (usually cobalt but sometimes nickel or manganese). The energy it stores (≈180 Wh/kg) at an average voltage of 3.8 V is a factor of 5 higher than that stored by the much older lead-acid batteries.

A great deal of research has been directed towards developing better materials for cathode, anode, electrolyte, binders, etc. More focus has been on the cathode and anode materials as they are the principal components of the battery architecture. This has led to commercial availability of a diverse array of cathode and anode materials, although the current anode materials are dominated by carbon-based materials. Higher capacity alloying anode materials like silicon and tin have not been adopted commercially, because of the various challenges they impose towards efficient functioning of these materials in lithium-ion batteries.

Silicon (Si) has been one of the most widely researched anode materials due to the high theoretical capacity it provides. The practical limit of Si anode capacity is 4200 mAh/g in the pure phase. Along with such impressive theoretical values, Si is the second most abundant element found in the Earth's crust and Si processing technology is also advanced due to the extensive Si use in a semiconductor (including photovoltaic) industry. Si anode research has thus developed at a rapid speed. The performance advantages and limitations of Si anodes as well as their operational and failure mechanisms (FIG. 2) have been studied extensively and the knowledge gained may serve as a basis to understand other types of alloying electrodes.

Upon lithiation, both amorphous Si (a-Si) and crystalline Si (c-Si) anodes first become amorphous and may later form a metastable Li₁₅Si₄ crystalline phase below ≈0.05 V versus Li. If initially crystalline, Si will expand anistropically, primarily in the <110> direction as seen in FIG. 3. This initial lithiation is thought to be limited by the reaction rate at the interface between the crystalline Si and amorphous lithiated phases. However, as the lithiated phase becomes thicker, the large volume change can cause GPa levels of stress to build up, especially at high charge rates. Nanostructures are therefore necessary to relieve the stress at the surfaces and provide necessary void space for expansion. Without such measures, stress will cause crack formation and limit capacity by inducing a large polarization.

Despite the significant progress in the field of Si anodes, no commercial anodes are currently based on Si or Si-containing composites, except in a few very recent designs utilizing a small quantity of small carbon-coated silicon oxide (SiOₓ)-containing particles added to graphite anodes to slightly increase their gravimetric capacity or pulse-power performance. Commercial adoption of silicon for lithium ion batteries will require further technology development and overcoming the main challenge of maintaining a constant particle volume and size and doing so with particles synthesized on a large commercial scale.

There is thus a need for improved binder materials that address at least some of the problems described above.

### SUMMARY

Accordingly, the present disclosure provides electrode binders with improved properties, their methods of preparation, and electrodes and energy storage devices comprising the same that overcome at least some of the issues described herein.

In a first aspect, provided herein is a binder for a battery electrode, the binder comprising chitosan and at least one phosphate salt or a conjugate acid thereof, wherein the at least one phosphate salt is selected from the group consisting of orthophosphate metal salts, pyrophosphate metal salts, and polyphosphate metal salts.

In a first embodiment of the first aspect, provided herein is the binder of the first aspect, wherein the at least one phosphate salt and chitosan are present in a 1:1 to 1:100 mass ratio.

In a second embodiment of the first aspect, provided herein is the binder of the first aspect, wherein the at least one phosphate salt is sodium tripolyphosphate.

In a third embodiment of the first aspect, provided herein is the binder of the second embodiment of the first aspect, wherein the sodium tripolyphosphate and chitosan are present in a 1:5 to 1:10 mass ratio.

In a second aspect provided herein is a binder composition for a battery electrode, the binder composition comprising the binder of the first aspect and a solvent.

In a first embodiment of the second aspect, provided herein is the binder composition of the second aspect, wherein the solvent is an aqueous solvent, a polar organic solvent, or a mixture thereof.

In a second embodiment of the second aspect, provided herein is the binder composition of the first embodiment of the second aspect, wherein the solid content of the binder composition is 1% wt/wt or greater.

In a third embodiment of the second aspect, provided herein is the binder composition of the first embodiment of the second aspect, further comprising at least one conducting additive and at least one anode active material; or at least one conducting additive and at least one cathode active material.

In a third aspect, provided herein is a lithium battery comprising: a positive electrode; a negative electrode disposed opposite to the positive electrode; and an electrolyte disposed between the positive electrode and the negative electrode, wherein at least one of the positive electrode and the negative electrode comprises the binder of the first aspect.

In a first embodiment of the third aspect, provided herein is the lithium battery of the third aspect, wherein the negative electrode comprises the binder of the first aspect and the negative electrode further comprises at least one conducting additive and at least one anode active material.

In a second embodiment of the third aspect, provided herein is the lithium battery of the first embodiment of the third aspect, wherein the at least one conducting additive is selected from the group consisting of carbon fiber, carbon nanofiber, carbon nanotubes, graphite, carbon black, graphene, and graphene oxide.

In a third embodiment of the third aspect, provided herein is the lithium battery of the first embodiment of the third aspect, wherein the at least one anode active material is selected from the group consisting of silicon and silicon oxide.

In a fourth embodiment of the third aspect, provided herein is the lithium battery of the third aspect, wherein the positive electrode comprises the binder of the first aspect and the positive electrode further comprises at least one conducting additive and at least one cathode active material.

In a fifth embodiment of the third aspect, provided herein is the lithium battery of the first embodiment of the third aspect, wherein the at least one phosphate salt is sodium tripolyphosphate, wherein the sodium tripolyphosphate and chitosan are present in a 1:7 to 1:10 mass ratio; the at least one conducting additive is selected from the group consisting of carbon fiber and carbon nanofiber; and the at least one anode active material is selected from the group consisting of silicon and silicon oxide.

In a fourth aspect, provided herein is a method for preparing the binder composition of the third embodiment of the second aspect, the method comprising: contacting chitosan; at least one phosphate salt selected from the group consisting of orthophosphate metal salts, pyrophosphate metal salts, and polyphosphate metal salts; at least one anode active material or at least one cathode active material; and a solvent thereby forming the binder composition of the third embodiment of the second aspect.

In a first embodiment of the fourth aspect, provided herein is the method of the fourth aspect, wherein the solvent is water comprising an organic acid.

In a second embodiment of the fourth aspect, provided herein is the method of the first embodiment of the fourth aspect, further comprising the step of removing the solvent by freeze drying thereby forming the binder composition of the third embodiment of the second aspect.

In a fifth aspect, provided herein is a binder composition prepared according to the method of the second embodiment of the fourth aspect.

In a first embodiment of the fifth aspect, provided herein is the binder composition of the fifth aspect, wherein the at least one phosphate salt is sodium tripolyphosphate, wherein the sodium tripolyphosphate and chitosan are present in a 1:7 to 1:10 mass ratio; the at least one conducting additive is selected from the group consisting of carbon fiber and carbon nanofiber; and the at least one anode active material is selected from the group consisting of silicon and silicon oxide.

In a sixth aspect provided herein is a lithium battery comprising: a positive electrode; a negative electrode disposed opposite to the positive electrode; and an electrolyte disposed between the positive electrode and the negative electrode, wherein at least one of the positive electrode and the negative electrode comprises the binder composition of the first embodiment of the fifth aspect.

### BRIEF DESCRIPTION OF DRAWINGS

The above and other objects and features of the present disclosure will become apparent from the following description of the disclosure, when taken in conjunction with the accompanying drawings, in which:

FIG. 1 shows the exemplary anode materials and cathode materials used in lithium ion batteries.

FIG. 2 shows a schematic detailing probably failure mechanisms of silicon anodes.

FIG. 3 shows scanning electron microscopy (SEM) images of (A) lithiation of Si pillars, showing their anisotropic growth in the <110> direction; and (B) initial lithiation and crack formation of a crystalline Si particle.

FIG. 4 shows a schematic representation of a possible lithiation mechanism of silicon anodes.

FIG. 5 shows a schematic illustration of the difference between carbon nanofibers (CNF) and conventional carbon fibers (CCF).

FIG. 6 shows a possible working mechanism of electrodes with multiple conducting additives.

FIG. 7 shows (A) and (B) show anode composite without binder before and after lithiation, respectively, while (C) and (D) show anode composite with binder before and after lithiation.

FIG. 8 shows (A) Crustaceans-source of chitosan, (B) Crustacean shells as food waste which contains chitosan, (C) Chemical structure of chitosan and (D) Commercially available chitosan powder.

FIG. 9 shows an exemplary reaction between cationic chitosan polymer crosslinked with anionic tripolyphosphate.

FIG. 10 shows a comparison of the swelling ratio of different dry binders.

FIG. 11 shows the peel force required to delaminate different types of anode material from copper foil.

FIG. 12 shows Fourrier transformed infrared spectroscopy (FTIR) spectra for Si, chitosanTPP, Si—C-chitosanTPP and Si-chitosanTPP washed samples.

FIG. 13 shows X-ray photoelectron (XPS) spectra of C₁ₛ of chitosanTPP, Si—C-chitosanTPP, washed Si—C-chitosanTPP and Si.

FIG. 14 shows XPS spectra of N₁ₛ of chitosanTPP, Si—C-chitosanTPP, washed Si—C-chitosanTPP and Si.

FIG. 15 shows FTIR spectra for fresh and cycled Si anode composite containing PVDF binder.

FIG. 16 shows FTIR spectra for fresh and cycled Si anode composite containing chitosan binder.

FIG. 17 shows C₁ₛ XPS spectra for fresh and cycled Si anode composite containing PVDF and chitosan binders.

FIG. 18 shows SEM images of Si-chitosan (A) and Si-PVDF (B) before cycling and Si-chitosan (C) and Si-PVDF (D) after 5 cycles.

FIG. 19 shows SEM images of Si—C-chitosanTPP-CNF composite-(A) before cycling and (B) after 500 charge/discharge cycles.

FIG. 20 shows energy-dispersive X-ray spectroscopy (EDS) analysis of Si anode composites prepared using chitosanTPP as binder.

FIG. 21 shows transmission electron microscopy (TEM) images of fresh composites (A): Si-chitosan and (B): Si-PVDF and after 5 cycles (C): Si-Chitosan and (D): Si-PVDF (image scale is 100 nm).

FIG. 22 shows magnified TEM images of (A) Si-chitosan and (B) Si-PVDF after 5 cycles, (image scale is 5 nm).

FIG. 23 shows cycling performance of Si—C-CNF-binder anodes using PVDF, chitosan and chitosanTPP as binder at 0.1C rate.

FIG. 24 shows cycling performance of Si—C-CNF-chitosan TPP anode at 0.1C rate.

FIG. 25 shows Nyquist plots of Si—C-CNF-chitosanTPP anode after the 1^{st} and 500^{th} discharge cycle.

FIG. 26 shows the rate performance of Si—C-CNF-chitosanTPP anode.

FIG. 27 shows the 1^{st} cycle discharge capacity of full cell batteries using Volt14 and carbon anodes along with LCO, NMC and LFP cathodes.

FIG. 28 shows active materials, conducting agents, binders and conducting polymers used in accordance with certain embodiments described herein.

FIG. 29 shows experimental steps involved in preparing and testing the batteries described herein.

FIG. 30 shows the components of a typical coin cell assembled inside a glove box.

FIG. 31 shows SEM images of (A) chitosan gel and (B) chitosan scaffold obtained through freeze drying method according to certain embodiments described herein.

FIG. 32 shows SEM images of Si-chitosanTPP anode (A) and (B) and Si-chitosanTPP scaffold anode (C) and (D) according to certain embodiments described herein. Scale for Figures (A) and (C) is 1 μm and for Figures (B) and (D) is 100 nm.

FIG. 33 shows SEM image of Si—C-CNF-chitosanTPP scaffold anode after 500 cycles according to certain embodiments described herein.

FIG. 34 shows TEM images of Si nanoparticles in Si—C-CNF-chitosanTPP scaffold anode after 10 cycles (A), 100 cycles (B) and 500 cycles (C) according to certain embodiments described herein.

FIG. 35 shows the FTIR spectra of Si—C-chitosanTPP, Si—C-CNF-chitosanTPP and Si—C-CNF-chitosanTPP Freeze dried anode composites according to certain embodiments described herein.

FIG. 36 shows the (A) cycling performance of Si—C-chitosan, Si—C-chitosanTPP, Si—C-CNF-chitosanTPP and freeze-dried Si—C-CNF-chitosanTPP anodes at 0.1C; and (B) shows specific discharge capacity at the first cycle and the 500^{th} cycle from FIG. 36A according to certain embodiments described herein.

FIG. 37 shows the (A) cycling performance of Si—C-CNF-chitosanTPP scaffold, Si—C-CNF-chitosanTPP, Si—C-CNF-chitosan and Si—C-CNF-PVDF anodes at 0.1C, based on specific discharge capacity (mAh/g-Si); and (B) shows specific discharge capacity at the first cycle and the 500^{th} cycle from FIG. 37A according to certain embodiments described herein.

FIG. 38 shows the cycling performance of Si—C-chitosanTPP-CNF scaffold anode at 0.1C according to certain embodiments described herein.

FIG. 39 shows Nyquist plots of Si—C-chitosanTPP-CNF scaffold and Si—C-chitosanTPP-CNF anodes after 1^{st} and 500^{th} discharge cycles according to certain embodiments described herein.

FIG. 40A shows an exemplary battery configuration according to certain embodiments described herein.

FIG. 40B shows an exemplary battery configuration according to certain embodiments described herein.

FIG. 40C depicts an exemplary battery configuration according to certain embodiments described herein.

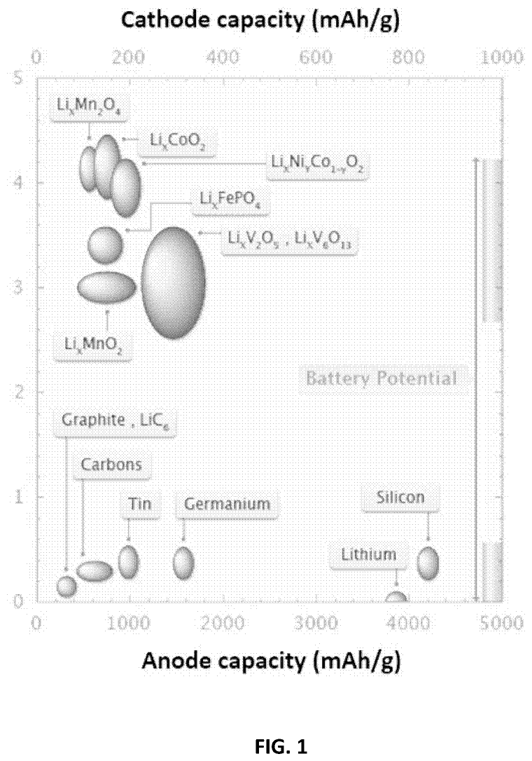

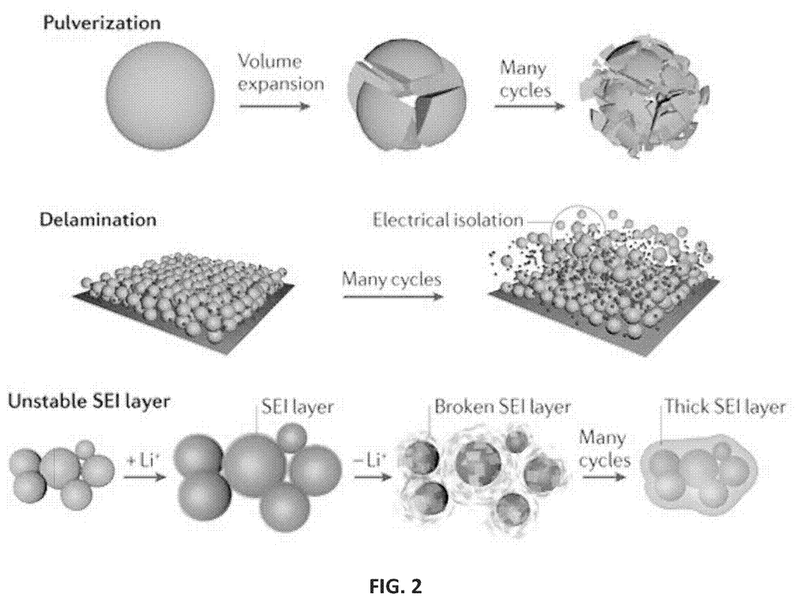

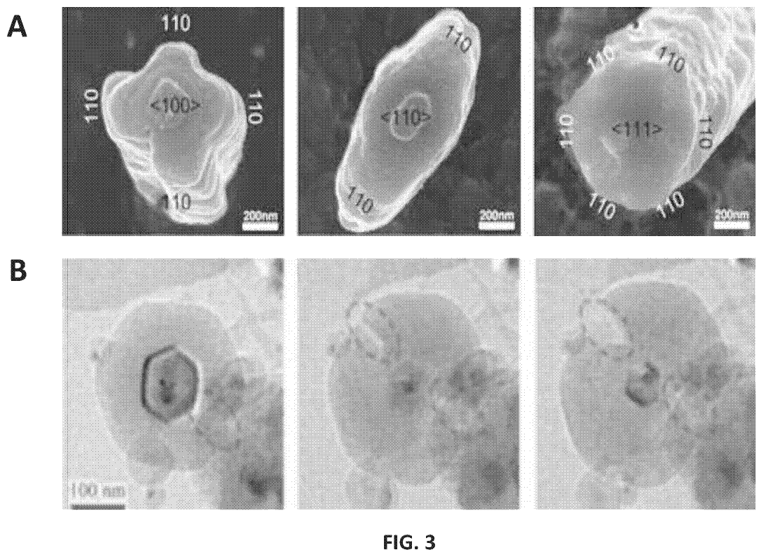

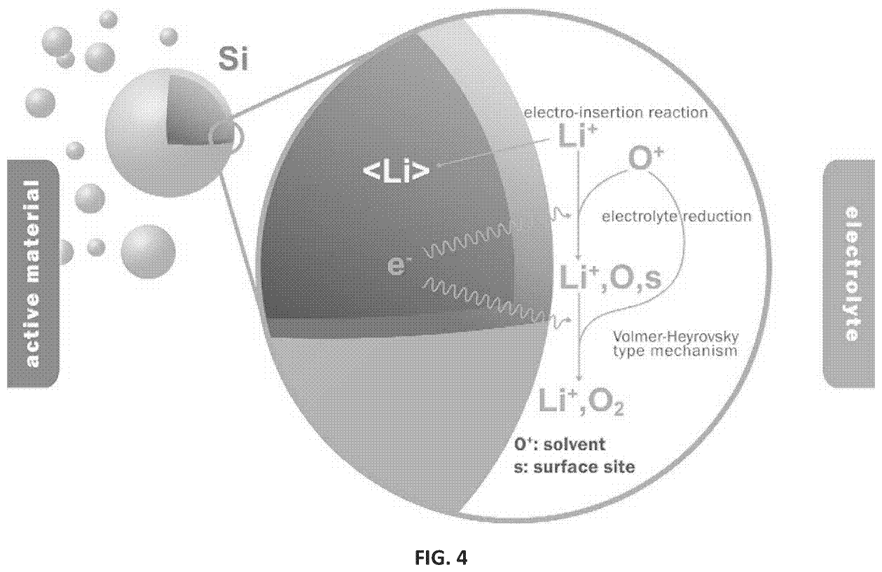

### DETAILED DESCRIPTION

### Definitions

The definitions of terms used herein are meant to incorporate the present state-of-the-art definitions recognized for each term in the field of biotechnology. Where appropriate, exemplification is provided. The definitions apply to the terms as they are used throughout this specification, unless otherwise limited in specific instances, either individually or as part of a larger group.

When trade names are used herein, applicants intend to independently include the trade name product formulation, the generic drug, and the active pharmaceutical ingredient(s) of the trade name product.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

The present disclosure is generally directed a composition comprising chitosan and at least one phosphate salt or a conjugate acid thereof for use as a binder for a battery electrode and electrodes and batteries comprising the same and methods of preparation thereof. The present disclosure is not to be limited in scope by any of the specific embodiments described herein. The following embodiments are presented for exemplification only.

Although binders only occupy 2-5% of the mass in typical commercial electrode configurations, the binder material is one of the most crucial electrode components for improved cell performance, especially for cycle life. Without the binder, the active materials will lose contact with the current collector, resulting in capacity loss.

Properties of chitosan are influenced by several parameters, such as its molecular weight (10,000-1,000,000 Da) and degree of deacetylation (representing the ratio of 2-amino-2-deoxy-d-glucopyranose to 2-acetamido-2-deoxy-glucopyranose structural units in the chitosan). The degree of deacetylation of the chitosan used in the binders described herein can range from 0% to 100%. In certain embodiments, the degree of deacetylation of the chitosan used in the binders described herein is greater than 1%, greater than 5%, greater than 10%, greater than 20%, greater than 30%, greater than 40%, greater than 50%, greater than 60%, greater than 70%, greater than 80%, greater than 90%, greater than 95%, greater than 97%, greater than 98%, greater than 99%, or greater than 99.9%. In certain embodiments, the degree of deacetylation of the chitosan used in the binders described herein is between 50-100%, 60-99%, 65-99%, 65-99%, 65-99%, 70-99%, 75-99%, or 75-95%. In certain embodiments, the degree of deacetylation of the chitosan used in the binders described herein is between 75-95%.

The chitosan can have a molecular weight of 10,000-1,000,000 Da. In certain embodiments, the chitosan can have a molecular weight of 10,000-500,000; 20,000-500,000; 30,000-500,000; 40,000-500,000; 40,000-450,000; or 40,000-400,000 Da. In certain embodiments, the chitosan can be low molecular weight (molecular weight 50,000-190,000 Da), medium molecular weight chitosan (molecular weight 190,000-310,000 Da); or high molecular weight chitosan (molecular weight ˜310,000->375,000 Da).

Chitosan, a cationic copolymer of glucosamine and N-acetylglucosamine, is a partially deacetylated derivative of a natural polysaccharide-chitin, which is one of the most abundant carbohydrates in nature and is mostly derived from the exoskeleton of crustaceans. Chitosan has a unique set of useful characteristics such as bio-renewability, bio-degradability, biocompatibility, bio-adhesivity and nontoxicity. Chitosan and its derivatives are used in various fields such as pharmaceutical, biomedicine, water treatment, cosmetics, agriculture and food industry.

The binder and binders compositions provided herein take advantage of the unique properties of compositions comprising chitosan and phosphate salts or conjugate acids thereof. The binders and binder compositions described herein can be used in connection with any type of positive electrode or negative electrode known in the art. Accordingly, the embodiments that follow should not be viewed as limiting the use the binders and binder compositions described herein.

Chitosan can exist as a polycationic polymer, which is well known for its chelating properties. Therefore, interactions with negatively charged components, such as phosphate metal salts, can lead to the formation of a network ionically phosphate crosslinked chitosan chains. Ionic interactions between the negative charges of the phosphate and positively charged groups of chitosan are thought to be the major molecular interactions inside the crosslinked network. The formation of the network ionically phosphate crosslinked chitosan chains can be prepared by combining cationic chitosan and at least one phosphate salt; or in the alternative by combining neutral chitosan with the conjugate acid of at least one phosphate salt. Consequently, the binder compositions contemplated herein encompass binder compositions comprising chitosan and at least one phosphate salt or a conjugate acid thereof.

The binder provided herein can comprise chitosan and at least one phosphate salt selected from the group consisting of orthophosphate metal salts, pyrophosphate metal salts, and polyphosphate metal salts. In certain embodiments, the binder has 1, 2, 3, 4, or more different types of phosphate salts.

Polyphosphate metal salts suitable for use in the binder described herein include, but are not limited to, linear polyphosphate metal salts, metaphosphate metal salts, and branched polyphosphate metal salts. Exemplary polyphosphate metal salts include, but are not limited to, triphosphate salts, tetraphosphate salts, pentaphosphate salts, trimetaphosphate salts, tetrametaphosphate salts, and the like.

The at least one phosphate salt can comprise any metal cation. Exemplary metal cations include one or more cations selected from Group 1 and Group II of the Periodic Table of the Elements. In certain embodiments, the at least one phosphate salt can comprise one or more metal cations selected from the group consisting of Li⁺, Na⁺, Mg²⁺, and Ca²⁺. In certain embodiments, the at least one phosphate salt is a sodium orthophosphate, sodium pyrophosphate, or a sodium polyphosphate. In certain embodiments, the at least one phosphate salt is sodium tripolyphosphate. The binder can also comprise chitosan and at least one phosphate salt conjugate acid selected from the group consisting of conjugate acids of orthophosphate, pyrophosphate, and polyphosphate.

Conjugate acids of orthophosphate, pyrophosphate, and polyphosphate suitable for use in the binder described herein include, but are not limited to, linear polyphosphoric acids, metaphosphoric acids, and branched polyphosphoric acids. Exemplary polyphosphoric acids include, but are not limited to, triphosphoric acids, tetraphosphoric acids, pentaphosphoric acids, trimetaphosphoric acid, tetrametaphosphoric acids, and the like. In certain embodiments, the conjugate acid of the phosphate salt is polyphosphoric acid (CAS Number: 8017-16-1).

The conjugate acids of orthophosphate, pyrophosphate, and polyphosphate can comprise one or more ionizable protons and thus can exist in one or more conjugate acid protonation states. In instances in which the binder composition comprises a conjugate acid of orthophosphate, pyrophosphate, or polyphosphate, the conjugate acid can be in any of the possible protonation states of the phosphate salts described herein or a combination thereof. For example, conjugate acids of PO₄³⁻ (orthophosphate) include HPO₄²⁻, H₂PO₄⁻, and H₃PO₄; and conjugate acids of P₃O₁₀⁵⁻ (tripolyphosphate) include HP₃O₁₀⁴⁻, H₂P₃O₁₀³⁻, H₃P₃O₁₀²⁻, H₄P₃O₁₀¹⁻, and H₅P₃O₁₀. Anionic conjugate acids of the phosphate salts can comprise any one or more of the metal cations described herein.

The binder may comprise the at least one phosphate salt or a conjugate acid thereof and chitosan in a 1:1 to 1:10,000 mass ratio. In certain embodiments, the binder comprises the at least one phosphate salt and chitosan in a 1:1 to 1:10,000; 1:1 to 1:5,000; 1:1 to 1:1,000; 1:1 to 1:500; 1:1 to 1:250; 1:1 to 1:100; 1:1 to 1:20; 1:1 to 1:10; 1:5 to 1:10; 1:6 to 1:10; 1:7 to 1:10; 1:7 to 1:9; or 1:8 to 1:9 mass ratio. In certain embodiments, the binder comprises less than 1 part by weight of the at least one phosphate salt to 4 parts by mass of chitosan. In certain embodiments, the binder comprises the at least one phosphate salt in a mass ratio of less than 1 part by mass of the at least one phosphate salt to 5 parts by mass of chitosan; less than 1 part by mass of the at least one phosphate salt to 6 parts by mass of chitosan; less than 1 part by mass of the at least one phosphate salt to 7 parts by mass of chitosan; less than 1 part by mass of the at least one phosphate salt to 8 parts by mass of chitosan; or; less than 1 part by mass of the at least one phosphate salt to 9 parts by mass of chitosan. In the examples below, the binder comprises sodium tripolyphosphate and chitosan in a 1:8.3 mass ratio.

Chitosan is relatively insoluble in water and in most organic and alkali solvents. However, chitosan is soluble in solvents comprising dilute organic acids, such as acetic acid, formic acid, lactic acid, oxalic acid, benzoic acid, and lactic acid. Provided herein is a binder composition comprising the binder described herein and a solvent optionally comprising an organic acid. The solvent may be an aqueous solvent, a polar organic solvent, or a mixture thereof. Suitable polar organic solvents include, but are not limited to, alcohols, alkyl halides, dialkylformamides, dialkyl ketones, dialkyl sulfoxides, tertiary amides, and combinations thereof. Exemplary polar organic solvents include, but are not limited to, methanol, ethanol, isopropanol, dimethylformamide (DMF), dimethylsulfoxide (DMSO), dimethylacetamide (DMA), acetone, methyl ethyl ketone, and N-methyl-2-pyrrolidone. The organic acid may be acetic acid, propionic acid, formic acid, lactic acid, oxalic acid, succinic acid, tartaric acid, malic acid, benzoic acid, methylsulfonic acid, phenylsulfonic acid, toluenesulfonic acid, or a combination thereof. The organic acid may be present in the solvent at a concentration of about 0.1-5% v/v. In certain embodiments, the organic acid is acetic acid. In instances in which a conjugate acid of the phosphate salt is used, it can be used in place of the organic acid to solubilize chitosan in a solvent, such as water.

The binder composition may have a solids content of 0.1% wt/wt or greater, wherein the solids content is determined according to the formula: (weight of the at least one phosphate salt+weight of chitosan)/(weight of solvent+weight of the at least one phosphate salt+weight of chitosan). In certain embodiments, the binder has a solids content of 0.5% wt/wt, 1.0% wt/wt, 1.5% wt/wt, 2.0% wt/wt or greater. In certain embodiments, the binder composition has a solids content between 0.1-20% wt/wt, 0.1-15% wt/wt, 0.1-10% wt/wt, 1-10% wt/wt, 1-5% wt/wt, 1-4% wt/wt, 1-3% wt/wt, or 1-1.5% wt/wt.

In certain embodiments, the binder composition comprises sodium tripolyphosphate and chitosan in an aqueous solution comprising acetic acid.

Also provided herein is an anode slurry comprising the binder composition described herein, at least one conducting additive, and at least one anode active material.

The anode active material can be any anode active material known in the art. In certain embodiments, the anode active material comprises a metal selected from Groups IA, IIA, IIIB and IVB of the Periodic Table of the Elements and compounds capable of forming intermetallic compounds and allows with metals selected from Groups IA, IIA, IIIB and IVB of the Periodic Table of the Elements. Examples of these anode active materials include lithium, sodium, potassium and their alloys and compounds capable of forming intermetallic compounds and alloys with lithium, sodium, potassium. Examples of suitable alloys include, but are not limited to, Li—Si, Li—Al, Li—B, Li—Si—B. Examples of suitable intermetallic compounds include, but are not limited to, intermetallic compounds that include or consist of two or more components selected from the group consisting of Li, Ti, Cu, Sb, Mn, Al, Si, Pb, Sn, In, Bi, Ag, Ba, Ca, Hg, Pd, Pt, Te, Zn and La. Other examples of suitable intermetallic compounds include, but are not limited to, intermetallic compounds that comprise lithium metal and one or more components selected from the group consisting of Ti, Cu, Sb, Mn, Al, Si, Pb, Sn, In, Bi, Ag, Ba, Ca, Hg, Pd, Pt, Te, Zn, and La. Other suitable anode active materials include lithium titanium oxides such as Li₄Ti₅O₁₂, silica alloys, and mixtures of the above anode active materials. The anode active material may be a graphite-based material, such as natural graphite, artificial graphite, coke, and carbon fiber; a compound containing at least one element such as Al, Si, Sn, Ag, Bi, Mg, Zn, In, Ge, Pb, and Ti, which can alloy with lithium, sodium, or potassium; a composite composed of the compound containing at least one element which can alloy with lithium, sodium, or potassium, the graphite-based material, and carbon; or a lithium-containing nitride; and combinations thereof.

In certain embodiments, the anode active material is silicon nanoparticles, monocrystalline silicon nanoparticles, monocrystalline silicon nanoflakes, silicon powder, silicon oxide, silicon oxide nanoparticles, SiOₓ particles, wherein x is 0.1 to 1.9, silicon nanotubes, silicon nanowires, tin nanopowder, tin oxide nanopowder, and combinations thereof.

The conducting additive present in anode and/or cathode can be a carbon conducting additive, a polymer conducting additive, a metal conducting additive, or a combination thereof. Suitable carbon conducting additive include, but are not limited to, natural graphite, artificial graphite, carbon fiber, carbon nanofibers, carbon black, acetylene black, Ketjen black, carbon nanotubes, graphene, graphene oxide, and combinations thereof. In certain embodiments, the conducting additive is a carbon conducting agent selected from the group consisting of carbon black nanopowder, carbon nanoparticles, double-walled carbon nanotubes, 3D graphene foam, graphene monolayer, graphene multilayer, graphene nanoplatelets, graphene oxide monolayer, graphene oxide paper, graphene oxide thin film, graphite nanofibers, graphite powder, graphite rods, and combinations thereof; a conducting polymer additive selected from the group consisting of polyacetylene, polypyrrole, poly(3,4-ethylenedioxythiophene):polystyrene sulfonate (PEDOT:PSS), polyaniline, polyparaphenylene vinylene, polyisothianaphthalene, polyparaphenylene sulphide, polyparaphenylene, and combinations thereof or a conducting metal additive selected from the group consisting of copper, nickel, aluminium, silver, and the like.

Generally, all types of conducting additives (including metal fibers, metal powders, graphite powders, carbon nanomaterials) can be used as conductive additives, but compared to metal fiber or metal powder, carbon nanomaterials have superior properties such as low weight, high chemical inertia and high specific surface area. Therefore, the most used conductive additives in lithium ion batteries are carbon nanomaterials, such as carbon black, Super P, acetylene black, carbon nanofibers, and carbon nanotubes. An ideal electrode for a lithium ion battery should have high electronic and ionic conduction. The electronic conduction depends on the electronic conductance of the electrode. The ionic conduction depends on the ionic diffusion which is closely related to the pores in the cathode. The porous structure, especially mesoporous structure can absorb and retain electrolyte solution, allowing intimate contact between the lithium ions and electrode active material.

Since the first CCF, which was prepared by carbonizing cotton and bamboo, was used as the filament of a light bulb in 1879 by Thomas Edison, it has been developed tremendously in both fundamental scientific research and practical applications. As one of the most important members of CCFs and CNFs have been applied as promising materials in many fields, such as energy conversion and storage, reinforcement of composites and self-sensing devices.

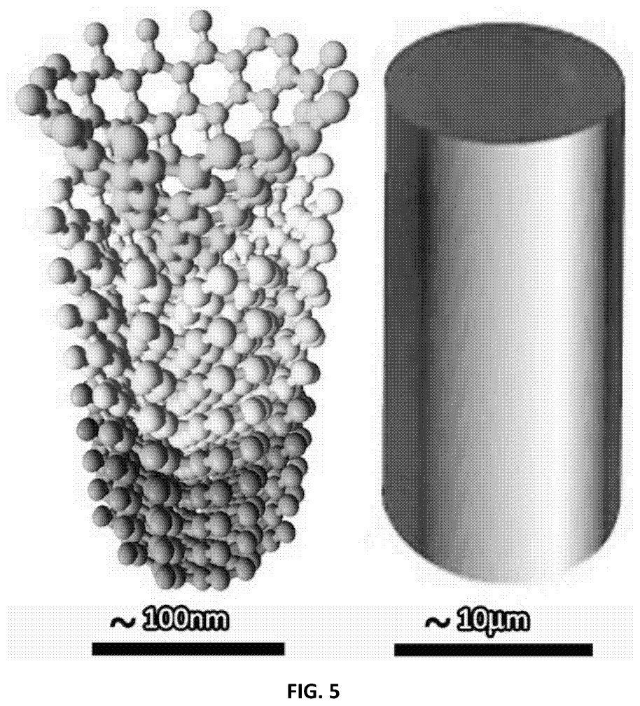

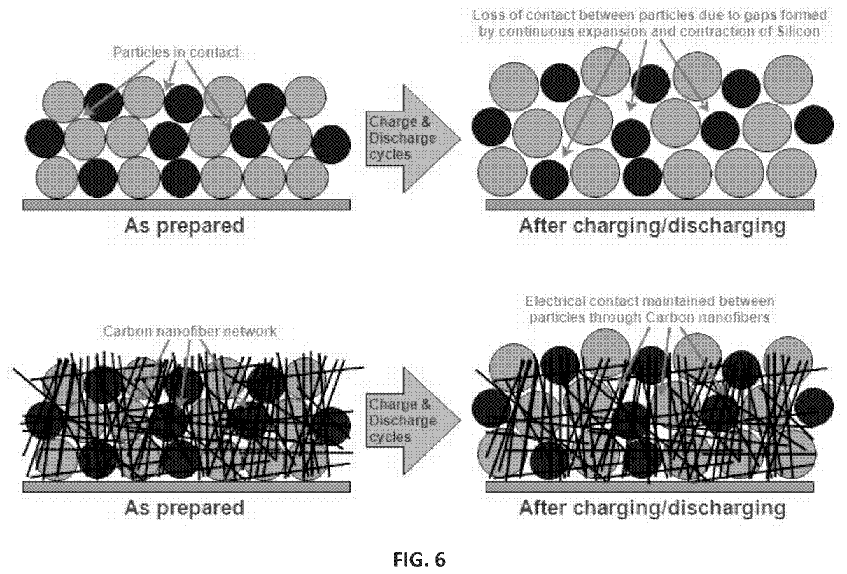

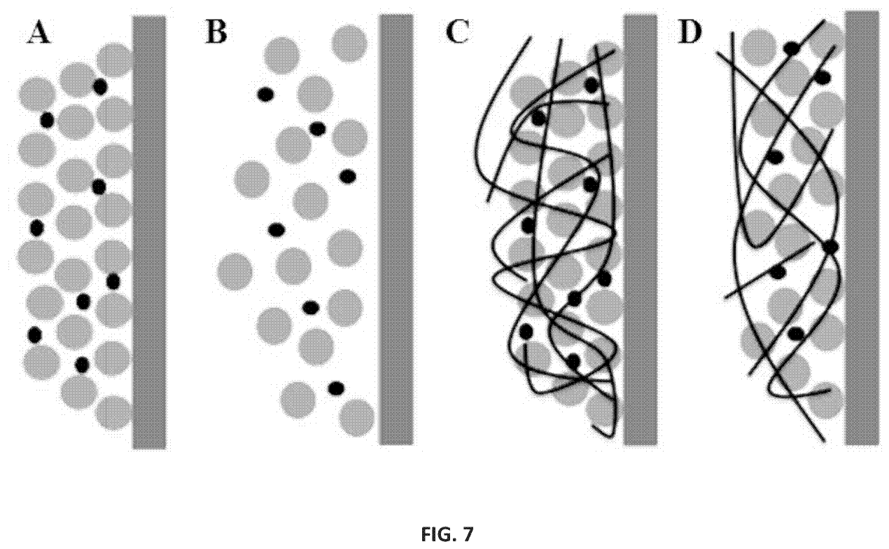

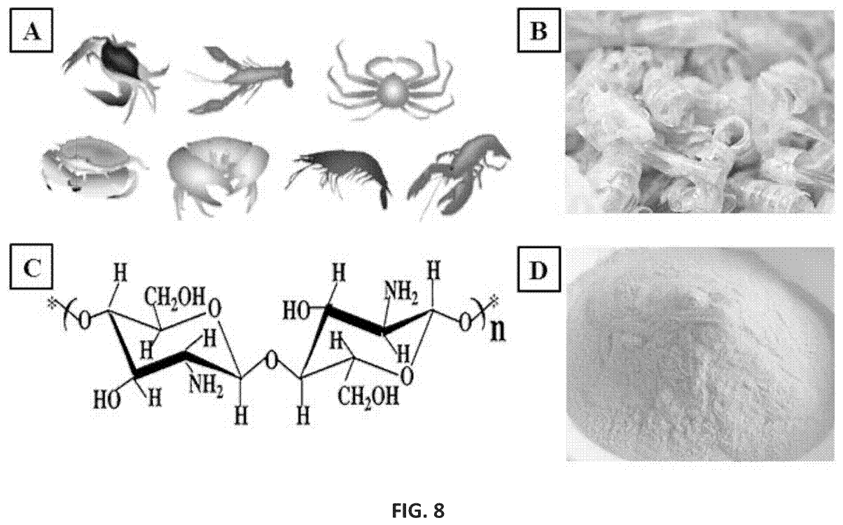

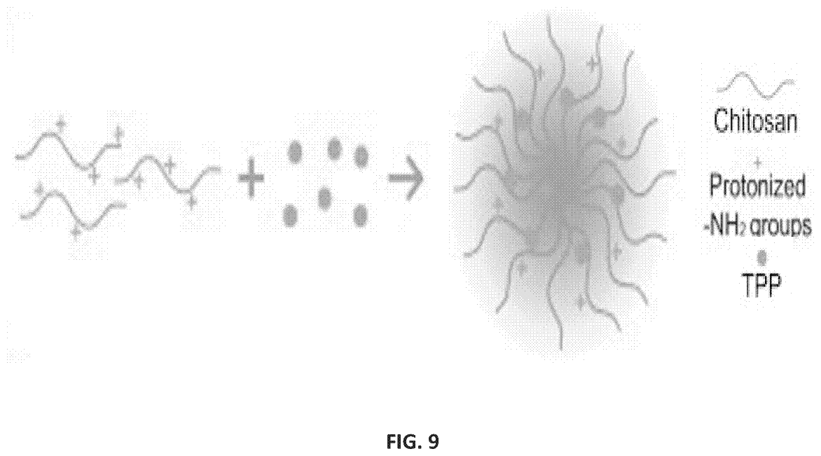

There are some differences between CCFs and CNF. The first one, also the most obvious one, is their size. The CCF can have diameters of several micrometers, while CNFs can have diameters of 50-200 nm. FIG. 5 shows a schematic illustration of the difference between CNF and CCF. Except the diameter; the structures of the CNFs are evidently different from traditional carbon fibers. The CNF can be mainly prepared by two approaches: catalytically vapor deposition growth and electrospinning.

One of the most important properties of CNF composites is their electrical conductivity. When the CNF composites are applied as electrical devices, sensors, electromagnetic shielding or electrodes for batteries or supercapacitors, the electrical conductivity is always the first priority need to be considered.

The conducting networks formed by the carbon nanofibers are less sensitive to inter-particle contact. These high-aspect-ratio additives are more efficient in increasing overall electronic conductivity for a given volume fraction. Compared with particulate carbon, carbon nanofiber can fix the cathode active materials to the current collector firmly and can keep the conductance of composite anode constant during the prolonged cycling, thus earning the nickname “physical binder”.

Compared with single conductive additives, multiple conductive additives can take advantages of two or more conductors, which can result in synergistic effects. Therefore, multiple conductive additives usually show some superiority over single conductive additives. For example, carbon black (CB) adheres on the surface of the cathode active material to enhance the conductivity of the cathode active material and CNF couples the cathode active material. Therefore, multiple conductive additives usually show some superiority over single conductive additives. Micro-sized graphite is easily dispersed with cathode active materials, but may not form a good conductive network when using small amounts. When nano-sized Super P or like is also added, a good conductive network can be formed resulting in a cathode that can have improved cyclic life and higher discharge capacity.

As discussed, fiber-like carbon can readily form a conductive network. However, fiber-like carbon can have less contact points with cathode active materials compared with particulate carbon. If particulate carbon and fiber-like carbon are mixed together to form multiple conductive additives, they will take advantages of the two kinds of conductors.

Binders keep particles in electrical contact, and are critical to assembling high-quality electrodes, regardless of the particle size. An ideal binder should provide best elasticity to the anode composite and should completely accommodate the expansion of the active material during the lithiation/delithiation process as shown in FIG. 7.

An anode slurry can be prepared by combining the binder composition described herein, at least one conducting additive, and at least one anode active material thereby forming the anode slurry.

The particle size of the anode slurry can optionally be reduced using any method known in the art.

There are various known methods for controlling the particle size of substances, including reduction by comminution or de-agglomeration by milling and/or sieving. Exemplary methods for particle reduction include, but are not limited to jet milling, hammer milling, compression milling and tumble milling processes (e.g., ball milling). Particle size control parameters for these processes are well understood by the person skilled in the art. For example the particle size reduction achieved in a jet milling process is controlled by adjusting a number of parameters, the primary ones being mill pressure and feed rate. In a hammer mill process, the particle size reduction is controlled by the feed rate, the hammer speed and the size of the opening in the grate/screen at the outlet. In a compression mill process, the particle size reduction is controlled by the feed rate and amount of compression imparted to the material (e.g. the amount of force applied to compression rollers).

In certain embodiments, the anode slurry is subjected to ball milling to reduce the particle size of the slurry.

The anode slurry can optionally be subjected to freeze drying thereby forming a freeze dried anode material, which can result in the formation of cavities (pores) within the formed freeze dried anode material that result in enhanced cycle stability of the anode. Moreover, freeze drying can advantageously enhance the rate capability, because the more porous structure of the freeze dried anode material increases ion transport in electrodes and accelerates the charge transfer reaction kinetics by the enhanced surface area.

Freeze drying the anode slurry can result in anode material having a much higher surface area than non-freeze dried anode material. For example, the freeze dried anode material can have an average surface area of between 20-40 m²/g, 20-35 m²/g, 25-35 m²/g, or 25-30 m²/g. Likewise, the total pore volume of the freeze dried anode material is also improved and can be in the range of 0.200 to 0.250 cm³/g, 0.200 to 0.240 cm³/g, 0.200 to 0.230 cm³/g, 0.210 to 0.230 cm³/g, or 0.220 to 0.230 cm³/g. The freeze dried anode material can have an average can average pore diameter of between 30-40 nm, 32-38 nm, or 32-36 nm.

To improve application of the freeze dried anode material to the negative electrode current collector, a slurry comprising the freeze dried anode material can be prepared by adding a solvent to the freeze dried anode material. Solvents useful in preparing the binder composition can be also be used to prepare the slurry comprising the freeze dried anode material.

The anode slurry can be coated on a negative electrode current collector, and heated, followed by further heat treatment in vacuum to form an electrode active material layer. In some embodiments, the coating may be performed using on or more methods selected from the group consisting of screen printing, spray coating, coating using a doctor blade, Gravure coating, dip coating, silk screen, painting, and coating using a slot die, depending on the viscosity of the slurry.

The negative electrode current collector may be any material having a conductivity without causing a chemical change in the lithium battery, for example, copper, stainless steel, aluminium, nickel, titanium, sintered carbon, or copper or stainless steel of which a surface is treated with carbon, nickel, titanium, silver, or the like, or an aluminium-cadmium alloy. Additional exemplary negative electrode current collectors include, but are not limited to copper foil, copper mesh foil, copper foam sheets, nickel foam sheets, nickel mesh foil, and nickel foil. In some embodiments, the negative electrode current collector may be in any of various forms, including a film, a sheet, a foil, a net, a porous structure, foam, and non-woven fabric.

Also provided herein is a cathode slurry comprising the binder composition described herein, at least one conducting additive, and at least one cathode active material.

Suitable cathode active materials include, but are not limited to, lithium transition metal oxides. The lithium transition metal oxide can include elements in addition to lithium, one or more transition metals and oxygen or can consist of lithium, one or more transition metals and oxygen. In instances where the lithium transition metal oxide includes cobalt as a transition metal, the lithium transition metal oxide can include more than one transition metal. In some instances, the lithium transition metal oxide excludes cobalt. The transition metal in the lithium transition metal oxide can include or consist of one or more elements selected from the group consisting of Li, Al, Mg, Ti, B, Ga, Si, Mn, Zn, Mo, Nb, V, Ag, Ni, and Co. Suitable lithium transition metal oxides include, but are not limited to, LiₓVO_{y}, LiCoO₂, LiNiO₂, LiNi_{1-x′}Co_{y′}Me_{z′}O₂, LiMn_{0.5}Ni_{0.5}O₂, LiMn_{1/3}Co_{1/3}Ni_{1/3}O₂, LiFeO₂, Li_{z}M_{yy}O₄, wherein Me is one or more transition metals selected from Li, Al, Mg, Ti, B. Ga, Si, Mn, Zn, Mo, Nb, V, Ag and combinations thereof and M is one or more transition metals such as Mn, Ti, Ni, Co, Cu, Mg, Zn, V, and combinations thereof. In some instances, 0<x<1 before initial charge of the battery and/or 0<y<1 before initial charge of the battery and/or x′ is ≥0 before initial charge of the battery and/or 1−x′+y+z=1 and/or 0.8<Z<1.5 before initial charge of the battery and/or 1.5<yy<2.5 before initial charge of the battery.

Additional examples of cathode active materials LiCoO₂, LiNiO₂, LiNi₁₋ₓCoyMe_{z}O₂, LiMn_{0.5}Ni_{0.5}O₂, LiMn_{(1/3)}Co_{(1/3)}Ni_{(1/3})O₂, and LiNiCo_{y′}Al_{z′}O₂.

The cathode slurry can be prepared by combining the binder composition described herein, at least one conducting additive, and at least one cathode active material thereby forming the cathode slurry.

In certain embodiments, the cathode slurry is subjected to ball milling to reduce the particle size of the slurry.

The cathode slurry can optionally be subjected to freeze drying thereby forming a freeze dried cathode material.

To improve application of the freeze dried cathode material to the positive electrode current collector, a slurry comprising the freeze dried cathode material can be prepared by adding a solvent to the freeze dried cathode material. Solvents useful in preparing the binder composition can be also be used to prepare the slurry comprising the freeze dried cathode material.

The cathode slurry can be coated on a positive electrode current collector, and heated, followed by further heat treatment in vacuum to form an electrode active material layer. In some embodiments, the coating may be performed using on or more methods selected from the group consisting of screen printing, spray coating, coating using a doctor blade, Gravure coating, dip coating, silk screen, painting, and coating using a slot die, depending on the viscosity of the slurry.

The positive electrode current collector may be any material having a high conductivity without causing a chemical change in the lithium battery, for example, stainless steel, aluminium, nickel, titanium, sintered carbon, or aluminium or stainless steel of which a surface is treated with carbon, nickel, titanium, silver, or the like. In some embodiments, the positive electrode current collector may have fine irregularities on a surface thereof so as to have enhanced adhesive strength to the positive active material. The positive electrode current collector may be in any of various forms, including a film, a sheet, a foil, a net, a porous structure, foam, and non-woven fabric.

In certain embodiments, provided herein is a lithium battery comprising: a positive electrode; a negative electrode disposed opposite to the positive electrode; and an electrolyte disposed between the positive electrode and the negative electrode, wherein at least one of the positive electrode and the negative electrode comprises a binder or binder composition described herein.

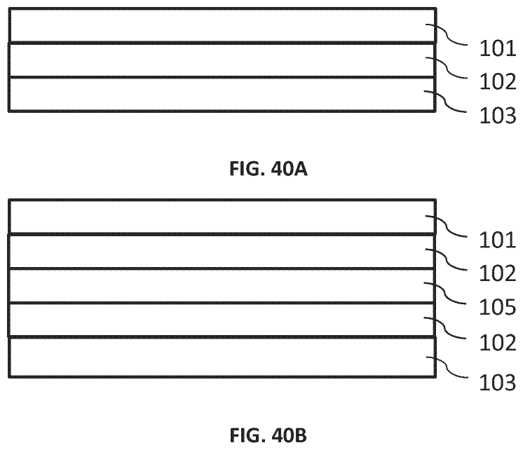

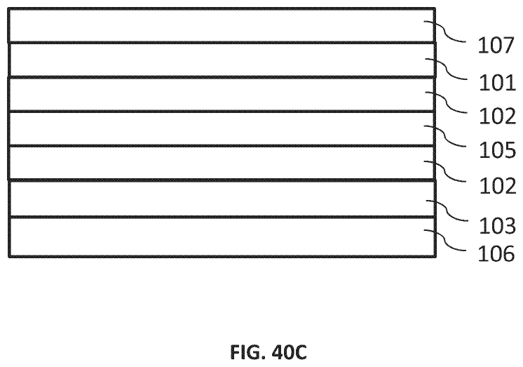

FIG. 40A depicts an exemplary battery configuration according to certain embodiments described herein, comprising a positive electrode 103; a negative electrode disposed opposite to the positive electrode 101; and an electrolyte disposed between the positive electrode and the negative electrode 102, wherein at least one of the positive electrode 103 and the negative electrode 101 comprises a binder or binder composition described herein.

The lithium battery can be of any type known in the art. Exemplary batteries include, but are not limited to, coin cell, cylindrical cell (including 18650 cells), pouch cell, and prismatic cell.

Any electrolyte known in the art can be used in the lithium battery described herein. In certain embodiments, the electrolyte is a lithium salt-containing non-aqueous electrolyte. For example, the non-aqueous electrolyte may be a non-aqueous liquid electrolyte, an organic solid electrolyte, or an inorganic solid electrolyte.

The non-aqueous liquid electrolyte can comprise at least one electrolyte solvent selected from propylene carbonate, ethylene carbonate, butylene carbonate, dimethyl carbonate (DMC), diethyl carbonate, methyl ethyl carbonate (MEC), fluoroethylene carbonate (FEC), γ-butyrolactone, methyl formate, methyl acetate, 1,2-dimethoxyethane, tetrahydrofuran, 2-methyltetrahydrofuran, dimethyl sulfoxide, 1,3-dioxolane, formamide, dimethylformamide, dioxane, acetonitrile, nitromethane, ethyl monoglyme, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, N-methyl acetamide, acetonitrile, acetals, ketals, sulfones, sulfolanes, aliphatic ethers, cyclic ethers, glymes, polyethers, phosphate esters, siloxanes, dioxolanes, and N-alkylpyrrolidones. In certain embodiments, the non-aqueous liquid electrolyte comprises EC, DMC, DEC, EMC, FEC, and combinations thereof.

Non-limiting examples of the organic solid electrolyte are polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Non-limiting examples of the inorganic solid electrolyte are nitrides, halides, sulfates, and silicates of lithium, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt may be any lithium salt that is in common use for lithium batteries, for example, any lithium salt that is soluble in the above-mentioned non-aqueous electrolytes. For example, the lithium salt may be at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NU, lithium chloroborate, lower aliphatic carboxylic acid lithium, lithium tetraphenyl borate, LiNO₃, lithium bisoxalatoborate, lithium oxalyldifluoroborate, and lithium bis(trifluoromethanesulfonyl)imide.

Exemplary electrolytes include, but are not limited to, LiPF₆ in EC:DMC=1:1 Wt %; EC:DEC:EMC=1:1:1 Vol %; EC:DEC=1:1 Vol % with 5.0% FEC; EC:DMC:DEC=1:1:1 Vol %; EC:DMC:EMC=1:1:1 Wt %; EC:DEC=1:1 Vol %; EC:DMC=1:1 Vol % with 5.0% FEC; EC:DEC=1:1 Wt %; EC:EMC=3:7 Vol %; EC:DMC:EMC=1:1:1 Vol %; and EC:DMC=1:1 Vol %.

In certain embodiments, provided herein is a lithium battery comprising: a positive electrode; a negative electrode disposed opposite to the positive electrode; a separator substrate disposed between the positive electrode and the negative electrode; and an electrolyte disposed between the separator substrate and the positive electrode and the separator substrate and the negative electrode; and wherein at least one of the positive electrode and the negative electrode comprises a binder or binder composition described herein.

FIG. 40B depicts an exemplary battery configuration according to certain embodiments described herein, comprising a positive electrode 103; a negative electrode disposed opposite to the positive electrode 101; a separator substrate 105 disposed between the positive electrode 103 and the negative electrode 101; and an electrolyte 102 disposed between the separator substrate 105 and the positive electrode 103 and the separator substrate 105 and the negative electrode 101; and wherein at least one of the positive electrode 103 and the negative electrode 101 comprises a binder or binder composition described herein.

In certain embodiments, the separator substrate 105 is selected from polyolefin, fluorine-containing polymers, cellulose polymers, polyimides, nylons, glass fibers, alumina fibers, porous metal foils, and combinations thereof.

The separator substrate 105 can be made from a polyolefin. Exemplary polyolefins include, but are not limited to, polyethylene (PE), ultra-high molecular weight polyethylene (UHMWPE), polypropylene (PP), polymethylpentene (PMP), polybutylene, copolymers of any of the foregoing, and mixtures thereof. In certain embodiments, the separator substrate 105 is a polyolefin, such as polyethylene, polypropylene, polybutylene, or combinations thereof (e.g., Celgard® separators, Celgard LLC, Charlotte, N.C., US). The separator substrate 105 can be made by either a dry stretch process (also known as the CELGARD® process) or a solvent process (also known as the gel extrusion or phase separation process).

In certain embodiments, provided herein is a lithium battery comprising: a positive electrode current collector; a positive electrode; a negative electrode current collector; a negative electrode disposed opposite to the positive electrode; a separator substrate disposed between the positive electrode and the negative electrode; and an electrolyte disposed between the separator substrate and the positive electrode and the separator substrate and the negative electrode; and wherein at least one of the positive electrode and the negative electrode comprises a binder or binder composition described herein.

FIG. 40C depicts an exemplary battery configuration according to certain embodiments described herein, comprising a positive electrode current collector 106; a positive electrode 103; a negative electrode current collector 107; a negative electrode disposed opposite to the positive electrode 101; a separator substrate 105 disposed between the positive electrode 103 and the negative electrode 101; and an electrolyte 102 disposed between the separator substrate 105 and the positive electrode 103 and the separator substrate 105 and the negative electrode 101; and wherein at least one of the positive electrode 103 and the negative electrode 101 comprises a binder or binder composition described herein.

The negative electrode current collector 107 may be any material having a conductivity without causing a chemical change in the lithium battery, for example, copper, stainless steel, aluminium, nickel, titanium, sintered carbon, or copper or stainless steel of which a surface is treated with carbon, nickel, titanium, silver, or the like, or an aluminium-cadmium alloy. Additional exemplary negative electrode current collectors 107 include, but are not limited to copper foil, copper mesh foil, copper foam sheets, nickel foam sheets, nickel mesh foil, and nickel foil. In some embodiments, the negative electrode current collector 107 may be in any of various forms, including a film, a sheet, a foil, a net, a porous structure, foam, and non-woven fabric.

The positive electrode current collector 106 may be any material having a high conductivity without causing a chemical change in the lithium battery, for example, stainless steel, aluminium, nickel, titanium, sintered carbon, or aluminium or stainless steel of which a surface is treated with carbon, nickel, titanium, silver, or the like. In some embodiments, the positive electrode current collector 106 may have fine irregularities on a surface thereof so as to have enhanced adhesive strength to the positive active material. The positive electrode current collector 106 may be in any of various forms, including a film, a sheet, a foil, a net, a porous structure, foam, and non-woven fabric.

In a comparative example, chitosan was used as binder for Si anode. Performance of chitosan as a binder was found to be better when compared to other commonly used binders like PVDF and sodium alginate. The prepared coin cells were cycled at 0.1C for 5 cycles. This slow charging rate was used to allow proper lithiation of the Si nanoparticles and minimize cracks produced by rapid stresses. After cycling the cells were disassembled and the cycled composites were scrapped off the copper foils. This was followed by repeated and thorough washing with DMC to remove any traces of electrolyte residues and used for characterization and analysis.

Physical parameters like viscosity of gels play important roles in determining the gel strength and binding capabilities of the binders. The high viscosity of a binder solution prevents Si particles from sedimentation and aggregation during the electrode formation, as water is evaporating, resulting in high slurry uniformity. This uniformity is known to be critical for obtaining uniform distribution of active materials within the anode needed for the long-term electrode stability.

The viscosity of the different biopolymer gels and PVDF gel, all having concentration of 2% polymer in respective solvents, after fresh preparation and after 2 months of storage at room temperature are given in Table 1.

TABLE 1
Viscosity (cP) of freshly prepared 2% PVDF and biopolymer gels
and after 2 months of storage at room temperature.

| Binder | Freshly prepared | After 2 months of storage |
|---|---|---|
| PVDF in NMP | 82.8 | 82.8 |
| Alginate in water | 2089.8 | 2090.1 |
| Chitosan in 1% acetic acid | 3114.9 | 3114.7 |
| ChitosanTPP | 7138.4 | 7138.5 |

The viscosity of the chitosanTPP gel was significantly higher than that of chitosan gel because of the strong ionic bonds formed between the positive —NH₂ groups and the TPP anions. After storage at room temperature for 2 months, the viscosity of the PVDF and biopolymer gels were measured again to determine their storage stability. All the binder gels retained almost the same viscosity values which show their excellent stability during long-term storage under normal conditions. This is an important parameter which renders suitability to the biopolymer gels to be used for commercial purposes similar to that of the most commercially used binder PVDF.

Swelling tests were carried out in order to determine the interaction between the binder and the electrolyte. When the electrolyte swells into the binder matrix, it can easily migrate into the interface region between the binder and Si particles. The adhesion between the binder and silicon may thus be weakened, or even destroyed. In order to test the swelling property of the dry material of the binders, 20 ml each binder gels were dried to form pellets and soaked in 1M LiPF₆ in EC:DMC (1:1) electrolyte. The swelling ratios (weight ratio) were measured after 10 hours.

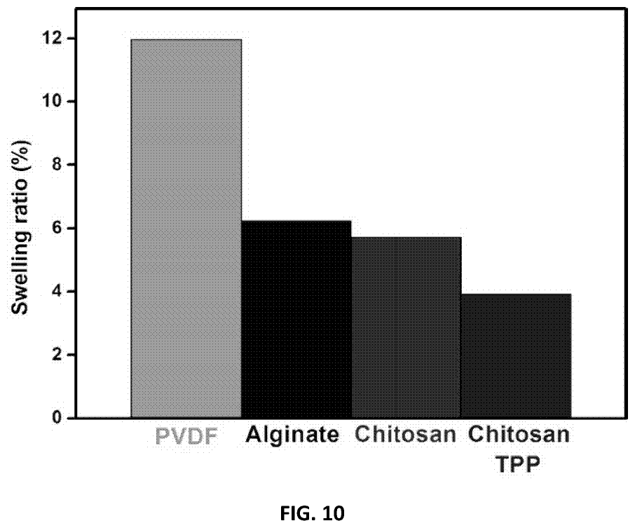

FIG. 10 shows that PVDF has the highest swelling in the electrolyte solution among the different binder gels used after 10 hours. ChitosanTPP showed the least amount of swelling in the electrolyte which may be due the strong ionic interaction between the chitosan and the tripolyphosphate ions which gives less interaction sites for the electrolyte molecules. Swelling of the binders in the electrolyte shows that the electrolyte can penetrate into the polymer binder network and establish contact with the Si active material, thus paving the way for the Li-ion diffusion into the anode matrix. Thus swelling of the binders in the electrolyte is advantageous for good ionic conduction inside the anode matrix, a very high swelling ratio for the PVDF implies stronger interaction between the PVDF and the electrolyte molecules which weakens the bonding between the binder and the Si nanoparticles and carbon and also between the anode matrix and the copper current collector.

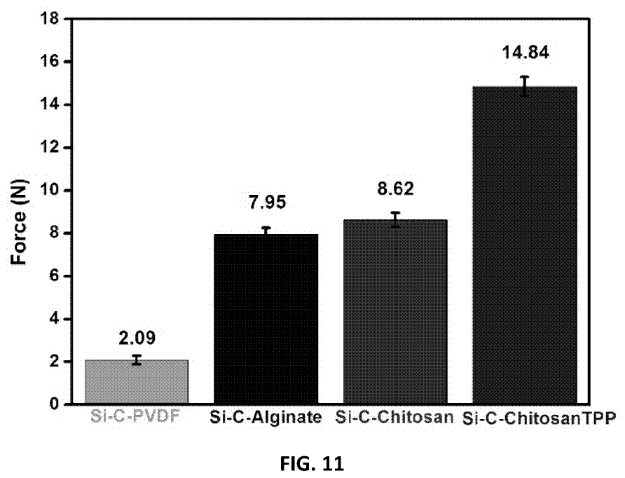

To quantitatively evaluate and compare the mechanical properties of the Si-chitosan and Si-chitosanTPP anode composites, adhesion tests were conducted according to a widely adopted 180° peeling test. As a reference, the peeling tests of the laminate using respectively the PVDF and sodium alginate binders were also conducted. According to the data presented in FIG. 11, the Si-PVDF composite shows the lowest initial peeling force of 2.09 N. The Si-Alginate composite exhibits higher mechanical properties than those of Si-PVDF and the initial peeling force increases to ca. 7.95 N. Si-chitosan composite shows slightly more initial peeling force of 8.62 N. Cross-linked with tripolyphosphate anions, the initial peeling force of chitosanTPP and Si composite is improved significantly, with as high as 14.84 N obtained. The adhesion test clearly indicates that the robust ionic bonds between chitosan chains and crosslinking moieties contribute to the higher mechanical strength, instead of weak physical crosslinks (probably van der Waals force and hydrogen bonds) between chitosan chains when no cross-linking agents were added, and thus forms a dense polymer network which confines the Si nanoparticles and does not let the electrolyte seep into the space between the composite and copper foil, thus increasing the adhesion between the binder and the copper foil.

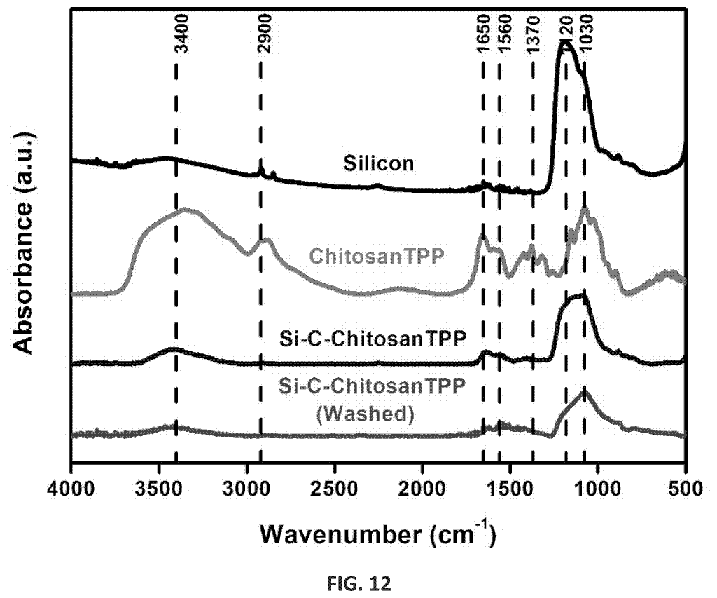

FTIR spectroscopy study was performed to determine the chemical bonds present in the binders and anode composites. The FTIR scans were performed between 400 to 4000 cm⁻¹ wavenumbers. To evaluate the interactions of chitosan and chitosanTPP with Si particles, the prepared anode slurries were dried under vacuum and immersed in large beakers filled with 2% acetic acid solution (chitosan solvent) and stirred for 4 hours. After filtering and drying in air, the Si particles were collected, immersed in 2% acetic acid solution, stirred for 4 hours, and filtered. This process was repeated five times. Before spectroscopy measurements, all samples were dried in a vacuum at 60° C. for 8 hours. FIG. 12 shows the FTIR spectra for Si, chitosanTPP, Si—C-chitosanTPP and Si-chitosanTPP washed samples. Chitosan exhibits a broad absorption band at 3400 cm⁻¹ related to hydrogen-bonded O—H stretching vibrations, peaks between at 1300 cm⁻¹ and 1650 cm⁻¹ corresponding to O—C—O (carboxylate) symmetric and asymmetric vibrations, a peak at 1410 cm⁻¹ corresponding to O—C—O symmetric vibrations, and a peak at 1100 cm⁻¹ related to C—O—C asymmetric vibrations, among others. After electrode formation, the relative intensity of the O—C—O and C—O—C peaks related to pyranose-ring deformation vibrations decreases considerably when compared with pure chitosan. This decrease provides evidence of a chemical interaction between the chitosan and Si nanoparticles. The peaks related to these interactions between chitosan and Si are strongly present in the repeatedly washed samples, suggesting strong binding effect of chitosan over Si nanoparticles. The strong interaction between the binder and the Si is one of the most critical factors affecting the stability of Si-based electrodes.

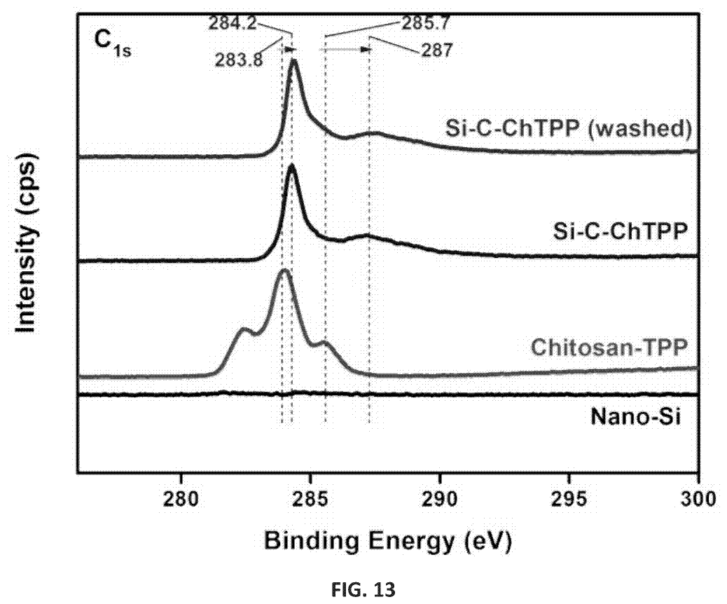

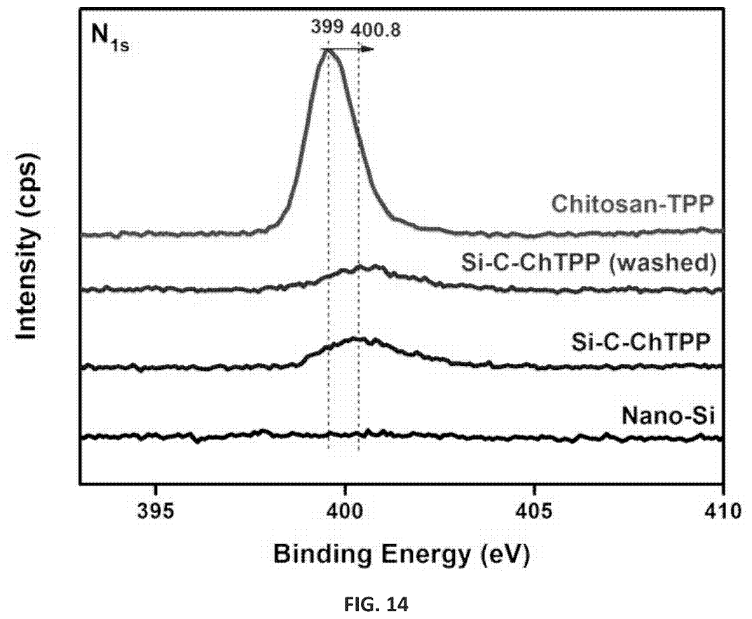

XPS measurements were done to confirm the results of the FTIR analysis. The XPS results provided further evidence of the strong bonding between the chitosanTPP binder and Si nanoparticles. As shown in FIGS. 13 and 14, the C₁ₛ XPS spectrum of the chitosanTPP showed three obvious characteristic peaks corresponding to C—C and C—H bonds (283.8 eV), C—O bond (285.7 eV) and C═O bond (283.0 eV). The N₁ₛ XPS spectrum also showed the strong N—H bond (399 eV) in chitosanTPP. As expected, the initial Si powder did not show any signs of C and N atoms on the surface. In spite of careful purification by washing with water for 4 times, the Si—C-chitosanTPP still showed strong C₁ₛ and N₁ₛ signals in XPS spectra, indicating that a large amount of C-chitosan still remained on the surface of Si nanoparticles. Comparing with chitosanTPP, the binding energy of C—H and C—O of the water-washed Si—C-chitosanTPP mixture increased from 283.8 to 284.2 eV and 285.7 to 287 eV, respectively, while the N1s signal shifted from 399 to 400.8 eV.

This implied that the —OH, —CH₂OH and —NH₂ groups of C-chitosan were bound to the hydroxylated Si surface and involved in the adsorption process, which was in good agreement with the FTIR analysis. These results suggested the formation of strong hydrogen bonding between the hydroxylated Si surface and chitosan.

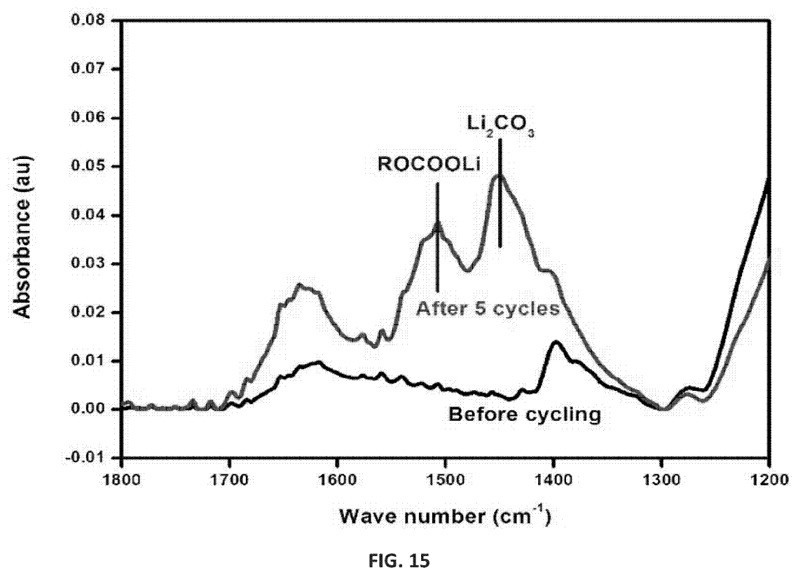

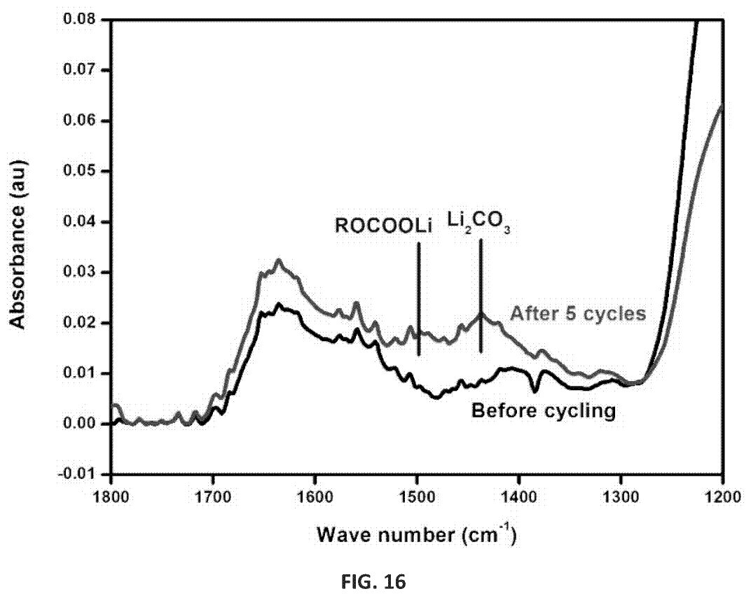

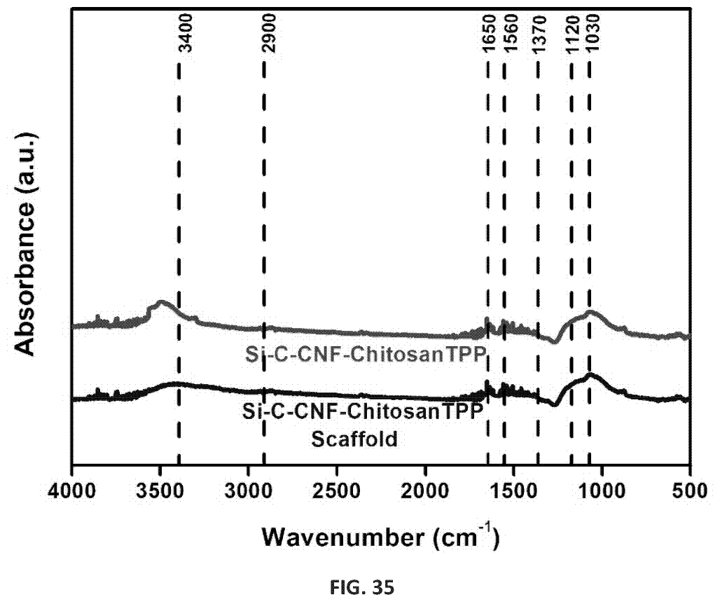

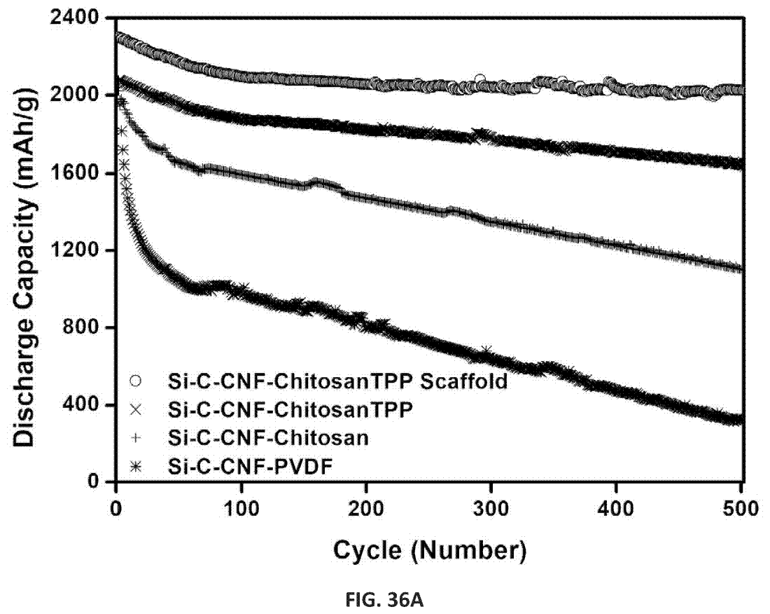

The IR spectra for fresh and cycled electrodes with PVDF and chitosan binders are shown in FIG. 15 and FIG. 16 respectively. The electrodes were cycled five times at 0.1C between 0.01 V and 1 V, cells disassembled inside the glove box, washed with DMC solvent thoroughly to remove residual electrolyte and then dried inside the glove box. Previous studioes have been done on a silicon anode using PVDF and polyacrylic acid binder, where they have shown that the formation of SEI layer is most vigorous in the first five cycles. The lower cut-off voltage was kept at 0.01V to allow for complete lithiation of the Silicon nanoparticles. The cycled anodes were put in air-tight containers containing silica gel desiccant, to prevent any contamination through contact with air or moisture, and then taken to MCPF lab for analysis. FTIR and XPS analyses were done to provide a better understanding about the role of binder on the formation of the SEI on Si electrodes. In FIG. 35, two peaks corresponding to ROCOOLi (1510 cm⁻¹) and Li₂CO₃ (1440 cm⁻¹) in the cycled composite were observed, which are absent in the fresh cathode material. These two compounds are the main decomposition products formed from the electrolyte during the cycling of the Si anodes and this indicated the formation of a SEI layer on the Si nanoparticles.

Contrary to the PVDF binder cathode, FIG. 16 shows no or very little traces of the ROCOOLi and Li₂CO₃ decomposition products for the chitosan binder anode. The chitosan binder forms a uniform layer on the Si nanoparticles and does not break during cycling, thus preventing any additional formation of ROCOOLi and Li₂CO₃ during cycling and contributing to a stable SEI layer on the Si nanoparticles present in the anode.

XPS analysis confirms the results obtained from the FTIR analysis. The C₁ₛ spectra of the fresh and cycled cathode composites show the formation of CO₃ peak (286.4 eV) in the cycled composite corresponding to the formation of Li₂CO₃. Though this peak is present in both the cycled PVDF and chitosan composites, the relative intensity of the peak present in the chitosan composite is much less compared to the PVDF composite. This shows that chitosan binder acts effectively in producing a stable SEI layer by reducing the amount of the electrolyte decomposition products.

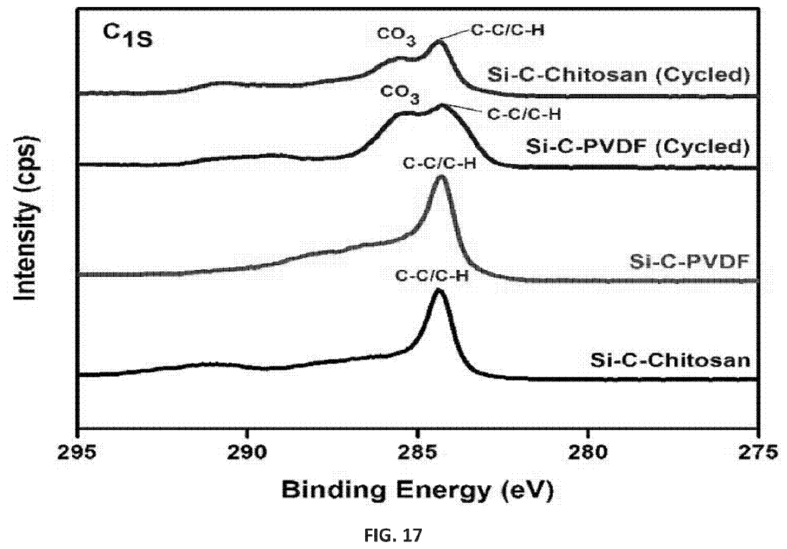

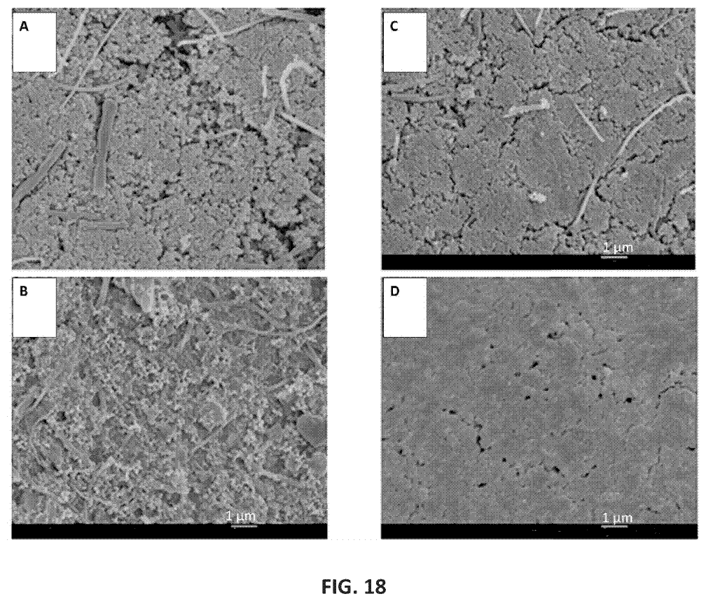

SEM images provide an understanding of the physical structure of the composite anode materials and the changes occurring in them during electrochemical testing. SEM images of the fresh and cycled composites are shown in FIG. 17. Both fresh composites consist of round shaped Silicon nanoparticles surrounded by Super P and CNF. After 10 cycles, the Si nanoparticles in the PVDF composite are covered with thick SEI making the boundary of the particles difficult to distinguish. The thick SEI may insulate the Si nanoparticles from the electrolyte, hindering the Li ion transfer and resulting in rapid capacity fading. On the contrary, the chitosan composite reveals clear individual particles with clean edges. The thinner SEI on the chitosan composite ensures good electric connection between particles during cycling, leading to better cyclability.

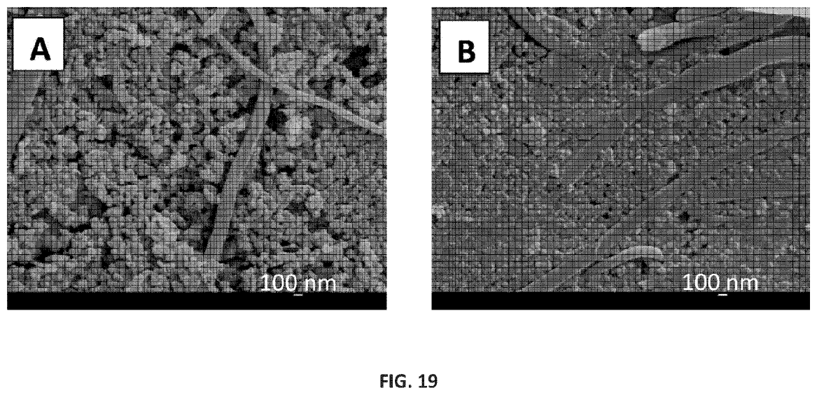

In FIG. 19, the surface morphology of the Si—C-chitosanTPP anode composite has been shown and compared with the surface morphology of the composite after 100 and 500 cycles of charging and discharging at 0.1C cycled between 0.1 and 1 V. The lower cut-off voltage was kept at 0.01V to allow for complete lithiation of the silicon nanoparticles. The anode composite has a very uniform morphology in which the Si, C Super P and Carbon nanofibers are well dispersed. The chitosanTPP binder is well coated on the nanoparticles, which gives it a smooth surface. The nanofibers make an additional cage like structure for the nanoparticles and increase the conductivity of the electrodes. After 500 cycles of charge/discharge there is slight decrease in the porosity of the anode due to the formation of the SEI layer on the Si nanoparticles but general structure of the anode composite is seen to be quite intact, suggesting excellent binding strength of chitosanTPP.

EDS analysis of the Si—C-chitosanTPP anode composite shows excellent dispersion of the Si, C and chitosanTPP binder. The chitosanTPP binder film is very evenly dispersed in the anode matrix, as shown by the EDS image for Phosphorus, which is present in the tripolyphosphate moieties of the chitosanTPP binder gel.

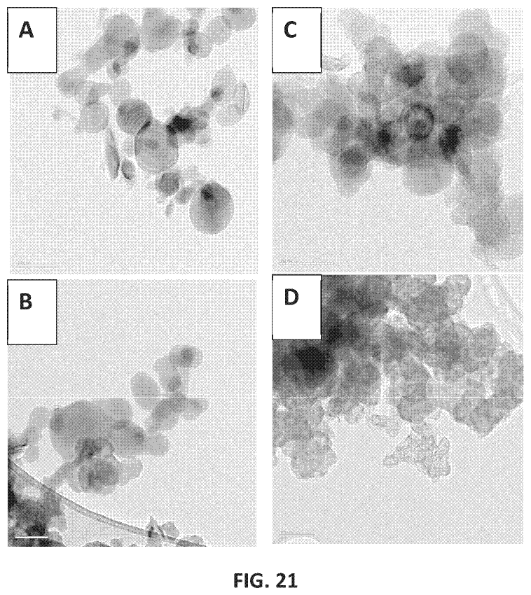

TEM analysis was done to further investigate the formation of the SEI layer on the Si nanoparticles. FIG. 21 shows the Si nanoparticles in the fresh and cycled anode composites with PVDF and chitosan binder. FIGS. 21A and 21B show clear round Si nanoparticles with clean edges in composites containing chitosan and PVDF binder respectively. FIG. 21C shows Si nanoparticles in cycled chitosan composite have more clear edges, though showing a bit fuzziness due to the formation of a thin SEI layer on the Si nanoparticles. In comparison, in FIG. 21D we can see that the Si nanoparticles in cycled PVDF composite have a fuzzy structure and the edges cannot be seen clearly. This is due to the formation of the SEI layer on the Si nanoparticles.

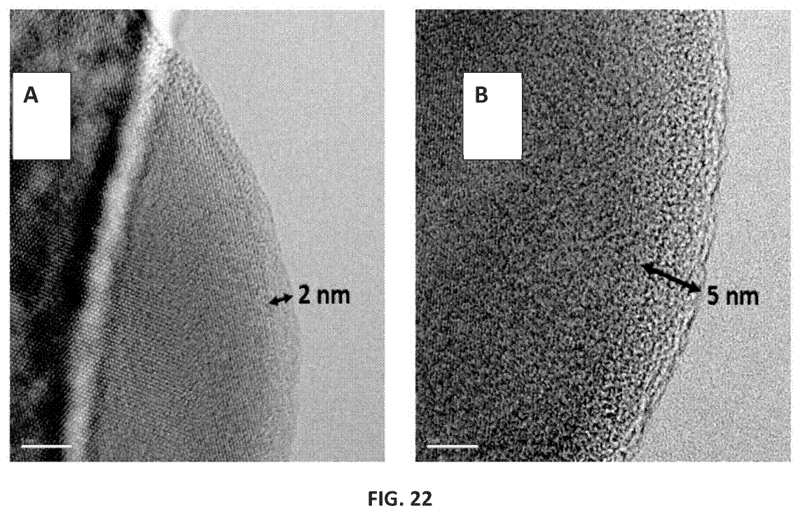

On further magnification of the TEM images of the two cycled composites, as shown in FIG. 22, one can see an amorphous layer on the crystalline Silicon nanoparticles. According to previous studies, this amorphous layer is made of the native SiOₓ formed due to oxidation of the Si nanoparticle surface during composite preparation, along with binder and SEI layer. This layer for the PVDF composite is much thicker (˜5 nm) than that on the chitosan composite (˜2 nm) after 5 cycles, owing to the formation of a more stable SEI layer by the chitosan binder compared to PVDF.

Half cells were prepared in the glove box and electrochemical measurements were done in a battery testing system. For most measurements, the current density was kept at 0.1C and the cells were charged and discharged between a voltage range of 0.01-1V. Three replicate coin cells were tested for each composite.

Anode composites were prepared using Si nanopowder, C Super P, CNF and binders, namely chitosan, chitosanTPP and PVDF. Loading of active material silicon in the composite was kept at 60% along with 15% CNF and 5% C Super P. The binder content was kept at 20%. Very high binder content can give low discharge capacity, because it is the electrically inactive component of the anode composite, while low binder content will reduce the capacity retention of the batteries due to loss of contact between the Si nanoparticles and carbon and also between the anode composite and the current collector due to constant expansion and contraction of the Si nanoparticles during cycling. The purpose of using CNF as a conducting agent is its excellent conductivity, almost four times that of C Super P. Resistivity of CNF is 8.2 Ω/sq as compared to C Super P with a resistivity of 35.1 Ω/sq.

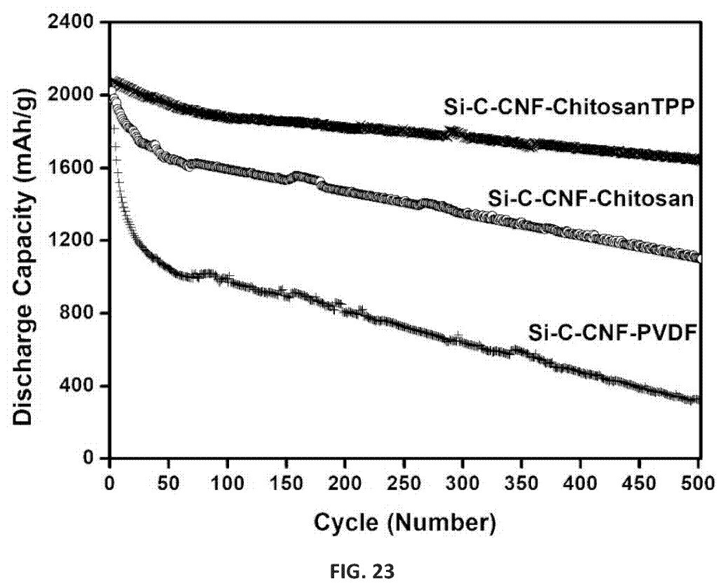

FIG. 23 shows that the chitosanTPP performs the best as a binder for Si anodes in comparison to PVDF and chitosan, when the anodes are cycled at 0.1C rate. The composition of Si—C-CNF-PVDF, Si—C-CNF-Chitosan, and Si—C-CNF-ChitosanTPP in FIG. 23 are shown in Table 2 below.

TABLE 2
Description of Si Anodes in FIG. 23.

| | Silicon | Carbon Super P | CNF | Binder |
|---|---|---|---|---|
| Composite | (wt. %) | (wt. %) | (wt. %) | (wt. %) |
| Si—C-CNF-PVDF | 60 | 15 | 5 | 20 |
| Si—C-CNF-Chitosan | 60 | 15 | 5 | 20 |
| Si—C-CNF-ChitosanTPP | 60 | 15 | 5 | 20 |

The initial discharge capacity of Si—C-CNF-chitosanTPP, Si—C-CNF-chitosan and Si—C-CNF-PVDF anodes were found out to be 2080 mAh/g, 2022 mAh/g and 2015 mAh/g, respectively. A trend of rapid decrease in discharge capacity was observed till about 85-100 cycles for all the anode composites. According to previous research, this rapid decease in capacity in the initial cycles corresponds to the formation of the SEI layer on the Si nanoparticles during cycling. After 100 cycles the Si—C-CNF-chitosanTPP and Si—C-CNF-chitosan anodes retained 90% and 78% of its initial discharge capacities, respectively, while the Si—C-CNF-PVDF anode retained only 48% of its initial discharge capacity. This result confirms the inability of PVDF to control the SEI layer formation, the binder layer breaking apart while cycling and exposing newer Si surfaces to the electrolyte components to combine and form more SEI layer compounds resulting in increase of thickness of the SEI layer and loss in discharge capacity due to isolation on the Silicon nanoparticles and increase in charge transfer resistance of the Li ions into the anode. In comparison the anodes using the chitosan based binders form a stable elastic layer on the Si nanoparticles thus limiting the exposure of the Si surface to the electrolyte components during cycling. Following this period of rapid capacity loss, the cycling performance of the anodes improved and the per cycle capacity loss decreased considerably. After 500 cycles the Si—C-CNF-chitosanTPP anode showed a discharge capacity of 1642 mAh/g, which was considerably higher than that of the Si—C-CNF-chitosan (1103 mAh/g) and Si—C-CNF-PVDF (323 mAh/g) anodes. The Coulombic efficiency values for all anodes made with different the binders were about 100% for all cycles.

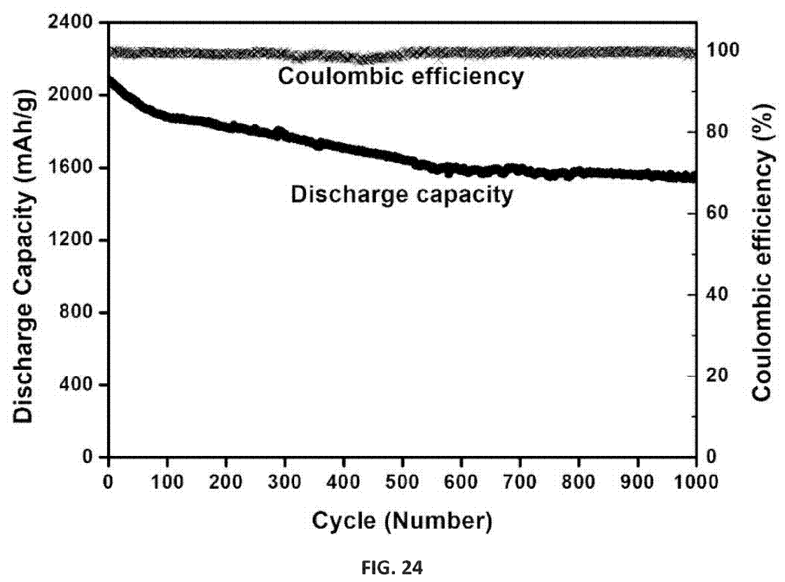

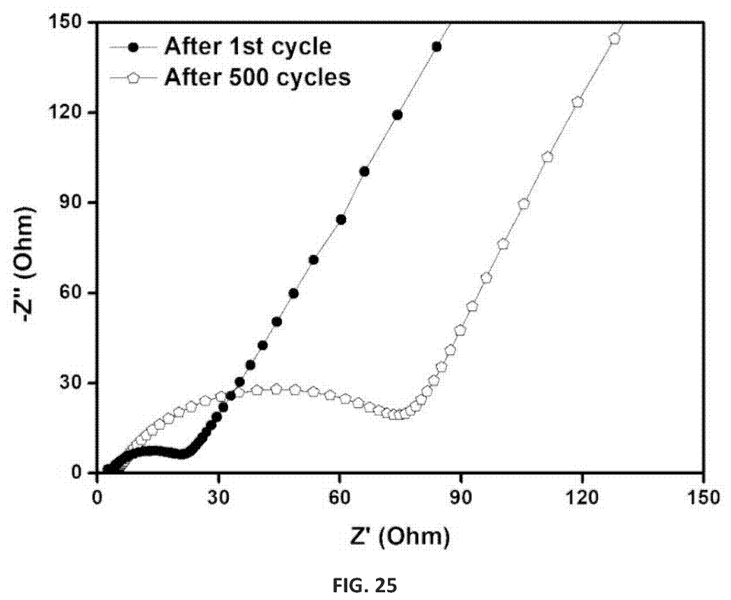

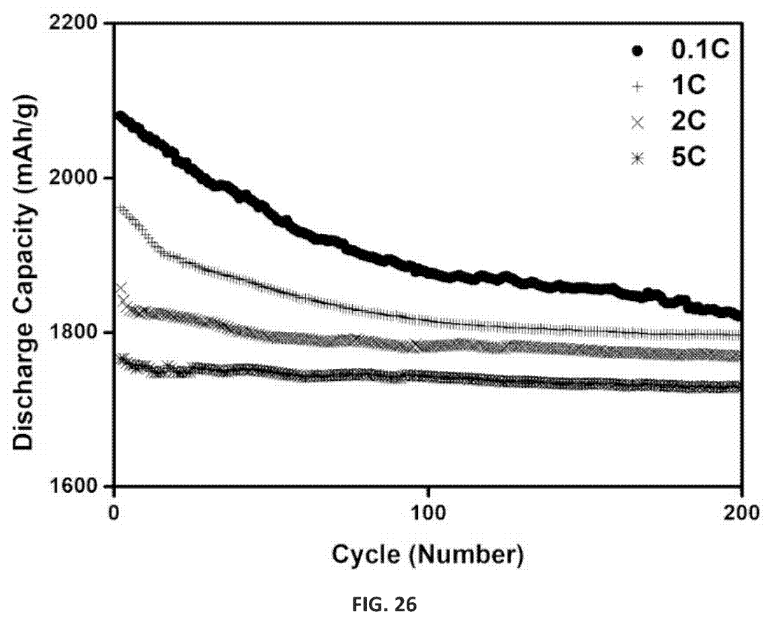

The Si—C-CNF-chitosanTPP anode was further cycled to 1000 cycles, as shown in FIG. 24. The discharge capacity of the anode after 1000 cycles was 1536 mAh/g, retaining about 74% of the initial discharge capacity. This excellent cycling stability can be attributed to the combined effect of the chitosanTPP binder and the CNF. The binder provides excellent adhesion between the different components of the anode and with the current collector foil and also forms a stable SEI layer on the Si nanoparticles. The CNF hold the electrode structure in its mesh during the cycling and provide excellent conductivity inside the anode, thus helping the anode achieve a very stable cycling performance.

For gaining further insight into Li-ion storage properties, electrochemical impedance spectroscopy (EIS) measurements for the Si—C-CNF-chitosanTPP anode was conducted after 1^{st} and 500^{th} discharge cycles. The Nyquist plots showed two depressed semicircles containing a high frequency semicircle (HFS) and a medium frequency semicircle (MHS) that overlapped with each other and a long low frequency line (LFL), all of which were relative to the SEI resistance, charge transfer resistance, and the Warburg impedance of Li⁺ diffusion in solid materials, respectively.

After the 1^{st} cycle, the charge transfer resistance (R_{ct}) of the anode, obtained by measuring the diameter of the semicircle, was found to be from 26Ω, which increased to about 74Ω after 500 cycles. This increase in R_{ct} can be attributed to the formation of the SEI layer on the Si nanoparticles, which hinders the diffusion of lithium ions into Si nanoparticle. The increase in R_{ct} was very less when compared to previous literature, where PVDF binder have been used, demonstrating that the formation of the SEI layer was limited, thus maintaining a stable cycling performance.

The rate performance of the Si—C-CNF-chitosanTPP anode was analysed by setting charge-discharge rates of 0.1C, 1C, 2C and 5C and cycling them for 200 cycles. The rate performance test helps judging the suitability of the anode material for faster charge and discharge rates, which is an important aspect to be considered for commercial applications. The anode showed remarkable stability and discharge capacity at higher charge-discharge rates. The discharge capacity of the anode after 200 cycles at 0.1C, 1C, 2C and 5C were found to be 1820 mAh/g, 1797 mAh/g, 1770 mAh/g and 1729 mAh/g, respectively.

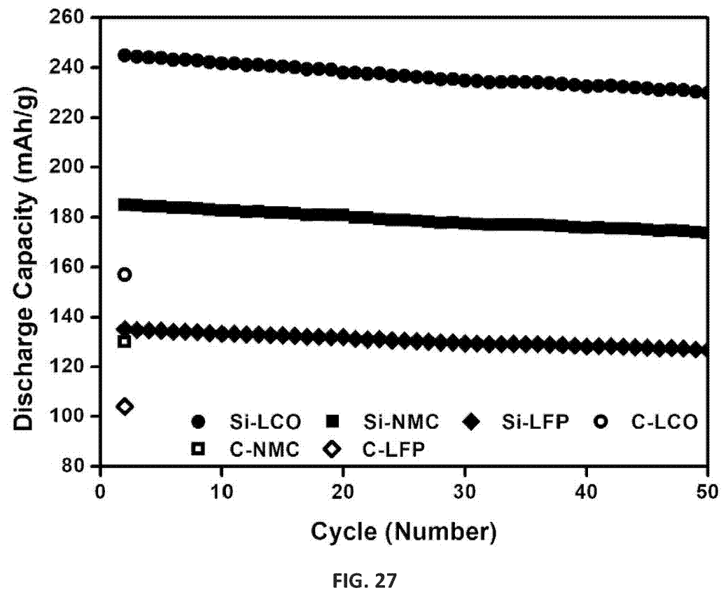

On basis of this finding the full cell performance of the battery when Si—C-CNF-chitosanTPP anode is used along with widely used commercial cathode materials, was carried out. The three most common cathode materials used in the industry were chosen for this study, namely, LCO, NMC, and LFP. The capacity comparison is shown in FIG. 27 below. The composition of Vot14 anode, Carbon anode, LCO cathode, NMC cathode, and LFP cathode in FIG. 27 are described in the table below.

TABLE 3
Description of Cathodes and Anodes in FIG. 27.

| Composite | Composition |
|---|---|
| Volt14 anode | Si (60 wt. %) + Carbon Super P (15 wt. %) + CNF |
| | (5 wt. %) + ChitosanTPP (20 wt. %) |
| Carbon anode | Artificial graphite (90 wt. %) + PVDF (10 wt. %) |
| LCO cathode | LCO (85 wt. %) + Carbon Super P (10 wt. %) + |
| | PVDF (5 wt. %) |
| NMC cathode | NMC (85 wt. %) + Carbon Super P (10 wt. %) + |
| | PVDF (5 wt. %) |
| LFP cathode | LFP (85 wt. %) + Carbon Super P (10 wt. %) + |
| | PVDF (5 wt. %) |

The batteries were cycled at 0.1C between 3.0-4.5 V. The batteries using Si—C-CNF-chitosanTPP anode had higher discharge capacity compared to the batteries using regular carbon anode. Taking the case of LCO, which has the highest discharge capacity among the cathode materials studied, the discharge capacity of the Si—C-CNF-chitosanTPP/LCO battery was found out to be 245 mAh/g. It was about 1.6 times higher than the discharge capacity of the C/LCO battery, which had a discharge capacity of 157 mAh/g.

### Experimental

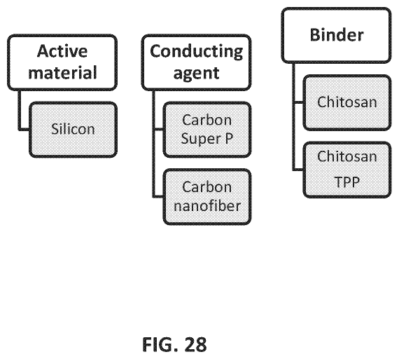

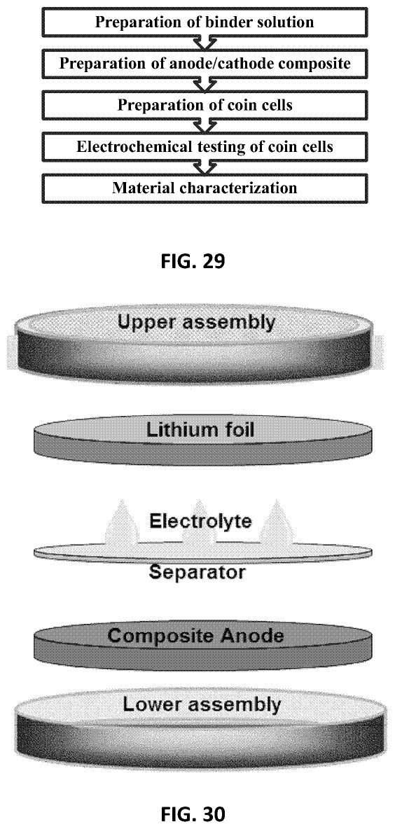

Different active materials, conducting agents, binders and conducting polymers were used in this study, as described in FIG. 28.

Silicon was chosen as anode active material because it has the highest theoretical discharge capacity of 4200 mAh/g, among alloying anode materials. Carbon Super P was used as the primary conducting C agent as it is one of the most commonly used conducting C agent. CNF was used as an additional conducting C agent because of its much higher conductivity than Carbon Super P. Chitosan was tested as binder as it is one of the cheapest and most abundant biopolymer found in nature and has also shown to improve cycling performance of electrodes compared to PVDF. ChitosanTPP, an ionically crosslinked polymer of chitosan, crosslinked with sodium tripolyphosphate, was used as a second binder in order to investigate its suitability for Si anodes, as it has been found to form much stronger gels compared to chitosan because of its crosslinked structure, which could help enhance the binding effect of chitosan by keeping the Si and C nanoparticles compact within crosslinked binder structure.

To compare the experimental results using chitosan and chitosanTPP as new binders, the most commonly used commercial binder PVDF and two well investigated biopolymeric binders, carboxymethyl cellulose and sodium alginate were employed as benchmark.

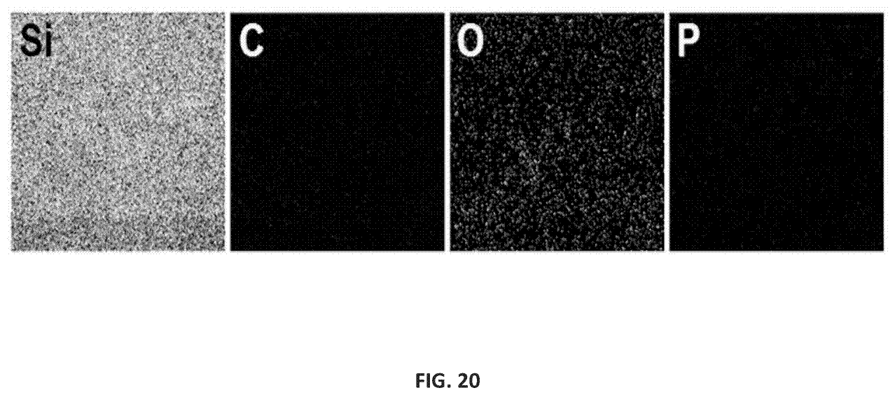

The different experimental steps involved in preparing and testing of the batteries are shown in FIG. 20.

Electrochemical testing was done for the coin cells to see their cycling performance, rate capability, charge-discharge profiles and internal resistance characteristics. Different material characterization techniques were adopted to understand the morphology and chemical structure of the different components present in the anode or cathode composites.

Materials

Silicon nanoparticle (<100 nm, 98%, CAS No.: 7440-21-3) was procured from Aldrich. Chitosan (medium molecular weight, CAS No.: 9012-76-4), Sodium alginate (medium viscosity, CAS No.: 9005-38-3) and sodium carboxymethyl cellulose (M_{w}-600,000, CAS No.: 9002-32-4) were procured from Aldrich. PVDF (<99.5%, M_{w}-600,000) was obtained from MTI Corporation. Acetic acid and N-methyl-2-pyrrolidone (NMP) were used as solvent for chitosan and PVDF respectively and were obtained from Aldrich. The electrolytes used were made by dissolving 1 M LiPF₆ in ethylene carbonate/dimethyl carbonate (1:1, v/v), purchased from Dodochem. Carbon Super P and Carbon nanofibers were obtained from Aldrich and used as received.

Methods

Preparation of Binder Gel Solutions

Chitosan was used as the principal biopolymer to investigate its suitability as a binder for Si anode and S cathode as active materials. PVDF and alginate were used as binders for Si anodes to compare with the performance of chitosan. Additionally, CMC were used as a binder for S cathode for comparison purposes. Some 2% binder solutions were prepared in a beaker with agitation using a magnetic stirrer and the preparation conditions are listed in Table 1. 1% m/v to 5% m/v chitosan solutions were prepared in 1% v/v acetic acid in water. The 1% solution was thin, and 3 to 5% chitosan solutions were very viscous that took long time to mix with. Anode slurries were prepared using the different concentration chitosan solutions and cast on copper foil. The slurry prepared with 2% chitosan was found to have the desired consistency for casting on copper foils. Moreover, the higher concentration binders did not mix properly with the Si and C during ball milling, resulting in non-homogeneous slurry. PVDF solution is mostly used in 2% m/v concentration in NMP and sodium alginate and CMC have also been previously used as 2% m/v concentration aqueous solutions for Si anodes.

TABLE 4
Preparation conditions for the different binder solutions.

| | | Mixing Time | Stirrer |
|---|---|---|---|
| Binder | Solvent | (hours) | speed (RPM) |
| PVDF | NMP | 1 | 500 |
| Sodium alginate | Deionized water | 12 | 600 |
| Chitosan | 1% acetic acid | 24 | 600 |
| | aqueous soln. | | |
| CMC | Deionized water | 6 | 600 |

The ionically cross-linked hybrid binders were prepared by mixing the alginate and chitosan binder gels with their respective crosslinking agents calcium and sodium tripolyphosphate. 14 mL of 6 mg/mL sodium tripolyphosphate (TPP) aqueous solution was added dropwise to 35 mL of 2% chitosan aqueous solution with 1% (v/v) acetic acid under mechanical stirring at 300 rpm for 48 hours. Chitosan binder gels were prepared from 14 mL of 1-10 mg/mL TPP and 35 mL of 2% chitosan aqueous solution with 1% (v/v) acetic acid. Lower concentration of TPP resulted in low viscosity gel solution, because of low degree of crosslinking. The viscosity and degree of crosslinking increased with increasing concentration of TPP. Low viscosity and degree of crosslinking resulted in low strength binder while too high viscosity and degree of crosslinking resulted in a binder gel which could not be used to make anode slurry because of high agglomeration of particles while mixing in a ball mill. 6 mg/mL TPP solution when combined with 35 mL of 2% chitosan aqueous solution with 1% (v/v) acetic acid, formed an optimum binder gel with relatively high degree of crosslinking and perfect viscosity which helped form a strong but uniform anode slurry.

The alginate-calcium cross-linked binder was prepared similarly by adding Ca²⁺ ions (obtained from dissolving calcium chloride in deionized water) to alginate gel, maintaining a molar ratio of 0.15 under mechanical stirring at 300 rpm for 24 hours.

Preparation of Electrode Composite Slurries

Anode slurries were prepared by mixing active material Si nanoparticles with conductive agents Super P or CNF, and binder gel solutions in a ball mill operating at 400 rpm for 6 hours. The proportion of the active material, conductive agent and binder gel were varied for different samples. The amount of active material varied between 40-50%, 50-60%, or 60-70%, the Super P 10-15%, 15-25%, or 25-40%, the CNF between 1-5%, 5-10%, or 10-15% and the binder between 10-15%, 15-20%, or 20-30% by dry weight. Halfway into the ball milling process the consistency of the slurry was checked and more solvent was added if needed.

Cathode slurries were prepared by mixing active material cathode powders, namely, lithium cobalt oxide (LCO), lithium nickel manganese cobalt oxide (NMC) and lithium iron phosphate (LFP), with PVDF binder solution and carbon conducting agent, in a ball mill operating at 250 rpm for 3 hours. The active material cathode powder, carbon conducting agent and PVDF binder was mixed in a ratio of 85:10:5 by dry weight. Halfway into the ball milling process, the consistency of the slurry was checked, and more solvent was added if needed.

Characterization of Binder Gels and Anode Composite Materials

Viscosity Measurement

Viscosity of the binder gel solutions were measured using a ARES-G2 rheometer (TA Instruments, USA).

A rheometer is a precision instrument that contains the material of interest in a geometric configuration, controls the environment around it, and applies and measures wide ranges of stress, strain, and strain rate. Material responses to stress and strain vary from purely viscous to purely elastic to a combination of viscous and elastic behavior, known as viscoelasticity. These behaviors are quantified in material properties such as modulus, viscosity, and elasticity.

Swelling Test

The tolerant capability of the binder systems with electrolyte solvent were examined by the swelling test. Solution-cast samples were prepared for swelling tests by drying 20 ml of binder gel solutions on petri dishes at 60° C. for 10 hours in a vacuum oven at −30 inch Hg vacuum pressure. The binder sheets were immersed in the electrolyte inside a glove box (MBraun Labstar) and weighed after ten hours to determine the amount of electrolyte absorption.

Peel Test

The adhesion strength of the binder for tethering the active Si nanoparticles and conductive carbon to the copper current collector was quantified using the 180° peel test. Anode slurry was prepared and cast on the copper foil and then dried under vacuum, in same way as done when preparing coin cells. Then a 30 mm wide and a 50 mm long piece of the coated copper foil was cut and immersed in 1M LiPF₆ in EC:DMC (1:1) electrolyte for ten hours inside the glove box. The copper foil will then be taken out of the glove box and peel test was done using an Instron universal testing machine. The foil was clamped in the lower clamp and an adhesive tape was attached on the coated side of the copper foil and on end of the tape was clamped in the upper clamp and then peeled off using the Instron tester. The peel force and displacement data were recorded.

X-Ray Diffraction

Crystal structure of the materials were examined by X-ray diffraction through Philips PW1830 powder X-ray diffractometer equipped with a Cu Kα radiation source (wavelength of 1.540562 Å) and graphite monochromator. The applied voltage and current were 40 kV and 20 mA, respectively, with a scan range of 20=0-80°. The step size and scan time were 0.05° and 2 s, respectively. The obtained spectrum was analyzed with Joint Committee on Powder Diffraction Standards (JCPDS) cards defined by the International Center for Diffraction Data.

X-ray diffraction works on the principle of interaction of the incident X-rays with a crystalline or amorphous substance to produce a diffraction pattern, depending upon the structural characteristics of the substance. Crystalline substances act as three-dimensional diffraction gratings for X-ray wavelengths similar to the spacing of planes in a crystal lattice. X-ray diffraction is based on constructive interference of monochromatic X-rays and a crystalline sample. These X-rays are generated by a cathode ray tube, filtered to produce monochromatic radiation, collimated to concentrate, and directed toward the sample. The interaction of the incident rays with the sample produces constructive interference (and a diffracted ray) when conditions satisfy Bragg's Law (nλ=2d sin θ). This law relates the wavelength of electromagnetic radiation to the diffraction angle and the lattice spacing in a crystalline sample. These diffracted X-rays are then detected, processed and counted. By scanning the sample through a range of 2θ angles, all possible diffraction directions of the lattice should be attained due to the random orientation of the powdered material. Conversion of the diffraction peaks to d-spacings allows identification of the mineral because each mineral has a set of unique d-spacings. Typically, this is achieved by comparison of d-spacings with standard reference patterns.

Scanning Electron Microscopy

The morphology of the anode and cathode composite materials were observed using a scanning electron microscope (SEM) using JOEL 6700 machine fitted with EDS analyser.

The scanning electron microscope uses a focused beam of high-energy electrons to generate a variety of signals at the surface of solid specimens. The signals that derive from electron-sample interactions reveal information about the sample including external morphology (texture), chemical composition, and crystalline structure and orientation of materials making up the sample. In most applications, data are collected over a selected area of the surface of the sample, and a 2-dimensional image is generated that displays spatial variations in these properties. Areas ranging from approximately 1 cm to 5 microns in width can be imaged in a scanning mode using conventional SEM techniques (magnification ranging from 20× to approximately 30,000×, spatial resolution of 50 to 100 nm). The SEM is also capable of performing analyses of selected point locations on the sample; this approach is especially useful in qualitatively or semi-quantitatively determining chemical compositions (using energy disruptive X-ray spectroscopy), crystalline structure, and crystal orientations (using electron backscatter diffraction).

The SEM is routinely used to generate high-resolution images of shapes of objects (SEI) and to show spatial variations in chemical compositions: 1) acquiring elemental maps or spot chemical analyses using energy disruptive X-ray spectroscopy, 2)discrimination of phases based on mean atomic number (commonly related to relative density) using backscatter electron detector, and 3) compositional maps based on differences in trace element “activitors” (typically transition metal and Rare Earth elements) using cathodoluminescence. The SEM is also widely used to identify phases based on qualitative chemical analysis and/or crystalline structure. Precise measurement of very small features and objects down to 50 nm in size is also accomplished using the SEM.

Fourier Transform Infra-Red Spectroscopy

Fourier Transform Infra-Red Spectroscopy (FTIR) was recorded using a Vertex 70 Hyperion 1000 spectrometer (Bruker, Germany) to evaluate the interactions between the different biopolymeric binders with the active materials.

Infrared spectroscopy is an important technique in organic chemistry. It is an easy way to identify the presence of certain functional groups in a molecule. Also, one can use the unique collection of absorption bands to confirm the identity of a pure compound or to detect the presence of specific impurities. FTIR relies on the fact that the most molecules absorb light in the infra-red region of the electromagnetic spectrum. This absorption corresponds specifically to the bonds present in the molecule. The frequency range are measured as wave numbers typically over the range 4000-400 cm⁻¹. The background emission spectrum of the IR source is first recorded, followed by the emission spectrum of the infrared source with the sample in place. The ratio of the sample spectrum to the background spectrum is directly related to the sample's absorption spectrum. The resultant absorption spectrum from the bond natural vibration frequencies indicates the presence of various chemical bonds and functional groups present in the sample. FTIR is particularly useful for identification of organic molecular groups and compounds due to the range of functional groups, side chains and cross-links involved, all of which will have characteristic vibrational frequencies in the infra-red range.

X-Ray Photoelectron Spectroscopy

The compositions of the materials and oxidation states of elements were measured via X-ray photoelectron spectroscopy (XPS) using a Kratos Axis Ultra DLD multi-technique surface analysis system, with an aluminum anode source operating at an applied power of 150 W.

X-ray photoelectron spectroscopy is a surface characterization technique that can analyze a sample to a depth of 2 to 5 nm. XPS reveals which chemical elements are present at the surface and the nature of the chemical bond that exists between these elements. It can detect all of the elements except hydrogen and helium. XPS is conducted in ultrahigh vacuum conditions, around 10-9 mbar, to eliminate any possible oxidation of the samples. Irradiating a sample with x-rays of sufficient energy results in electrons in specific bound states to be excited. In a typical XPS experiment, sufficient energy is input to break the photoelectron away from the nuclear attraction force of an element. Two key features are derived from XPS data. The first is that even photo-ejected electrons from core levels have slight shifts depending on the outer valence configuration of the material examined. The second is that the specific energy of an elemental core level transition occurs at a specific binding energy that can uniquely identify the element. In a typical XPS spectrum some of the photo-ejected electrons inelastically scatter through the sample enroute to the surface, while others undergo prompt emission and suffer no energy loss in escaping the surface and into the surrounding vacuum. Once these photo-ejected electrons are in the vacuum, they are collected by an electron analyzer that measures their kinetic energy. An electron energy analyzer produces an energy spectrum of intensity (number of photo-ejected electrons versus time) versus binding energy (the energy the electrons had before they left the atom). Each prominent energy peak on the spectrum corresponds to a specific element.

UV-Vis Spectrophotometry

UV-Vis spectrophotometry was done using a Lambda 20 (Perkin Elmer) spectrophotometer to determine the shift in absorption spectra for the different Li₂S₆-binder solutions.

Ultraviolet and visible (UV-Vis) absorption spectroscopy is the measurement of the attenuation of a beam of light after it passes through a sample or after reflection from a sample surface. Absorption measurements can be at a single wavelength or over an extended spectral range.

The region beyond red is called infra-red while that beyond violet is called as ultra-violet. The wavelength range of uv radiation starts at blue end of visible light (4000 Å) and ends at 2000 Å.

Ultraviolet absorption spectra arise from transition of electron with in a molecule from a lower level to a higher level when a molecule absorb ultraviolet radiation of a particular frequency. Every time a molecule has a bond, the atoms in a bond have their atomic orbitals merged to form molecular orbitals which can be occupied by electrons of different energy levels. Ground state molecular orbitals can be excited to anti-bonding molecular orbitals. These electrons when imparted with energy in the form of light radiation get excited from the highest occupied molecular orbital to the lowest unoccupied molecular orbital and the resulting species is known as the excited state or anti-bonding state.

Electrochemical Impedance Analysis

EIS is a powerful diagnostic tool that you can use to characterize limitations and improve the performance of fuel cells. There are three fundamental sources of voltage loss in fuel cells: charge transfer activation or “kinetic” losses, ion and electron transport or “ohmic” losses, and concentration or “mass transfer” losses. Among other factors, EIS is an experimental technique that can be used to separate and quantify these sources of polarization. By applying physically-sound equivalent circuit models wherein physiochemical processes occurring within the fuel cell are represented by a network of resistors, capacitors and inductors, one can extract meaningful qualitative and quantitative information regarding the sources of impedance within the fuel cell. EIS is useful for research and development of new materials and electrode structures, as well as for product verification and quality assurance in manufacturing operations.

During an impedance measurement, a frequency response analyzer (FRA) is used to impose a small amplitude AC signal to the battery via a load. The AC voltage and current response of the battery is analyzed by the FRA to determine the resistive, capacitive and inductive behavior, the impedance, of the cell at that particular frequency. Physicochemical processes occurring within the cell like electron & ion transport, liquid & solid phase reactant transport, heterogeneous reactions, etc. have different characteristic time-constants and therefore are exhibited at different AC frequencies. When conducted over a broad range of frequencies, impedance spectroscopy can be used to identify and quantify the impedance associated with these various processes.

Equivalent circuit modelling of EIS data is used to extract physically meaningful properties of the electrochemical system by modelling the impedance data in terms of an electrical circuit composed of ideal resistors (R), capacitors (C), and inductors (L). Because real systems do not necessarily behave ideally as the processes that occur are distributed in time and space, specialized circuit elements are often used. These include the generalized constant phase element (CPE) and Warburg element (ZW). The Warburg element is used to represent the diffusion or mass transport impedances of the cell.

In the equivalent circuit, resistors represent conductive pathways for ion and electron transfer. As such, they represent the bulk resistance of a material to charge transport such as the resistance of the electrolyte to ion transport or the resistance of a conductor to electron transport. Resistors are also used to represent the resistance to the charge-transfer process at the electrode surface. Capacitors and inductors are associated with space-charge polarization regions, such as the electrochemical double layer, and adsorption/desorption processes at an electrode, respectively.

EIS data for electrochemical cells such as fuel cells are most often represented in Nyquist and Bode plots. Bode plots refer to representation of the impedance magnitude (or the real or imaginary components of the impedance) and phase angle as a function of frequency. Because both the impedance and the frequency often span orders of magnitude, they are frequently plotted on a logarithmic scale. Bode plots explicitly show the frequency-dependence of the impedance of the device under test.

A complex plane or Nyquist plot depicts the imaginary impedance, which is indicative of the capacitive and inductive character of the cell, versus the real impedance of the cell. Nyquist plots have the advantage that activation-controlled processes with distinct time-constants show up as unique impedance arcs and the shape of the curve provides insight into possible mechanism or governing phenomena. However, this format of representing impedance data has the disadvantage that the frequency-dependence is implicit; therefore, the AC frequency of selected data points should be indicated. Because both data formats have their advantages, it is usually best to present both Bode and Nyquist plots.

Other Electrochemical Performance Measurements

The electrochemical performances of the anode composites were evaluated using CR2025 coin-type cells. The electrodes for electrochemical evaluation were prepared by coating the anode slurry on copper and aluminum foils using a glass rod. Then the coated copper or aluminum foils were dried in a vacuum oven at 60° C. for 8 hours. The electrodes were kept inside the Argon filled glove box for 12 hours for degassing. Lithium foils were used as counter electrodes, with Celgard 2325 microporous polypropylene/polyethylene/polypropylene tri-layer membrane serving as the separator. The as-prepared battery coin cells were used in galvanostatic charge-discharge tests that were conducted with a battery testing system (Neware CT-3008 W).

The cyclic voltammetry was performed on battery cells by Autolab PGSTAT100 electrochemical work station. The scan range was 2.0-4.8 V and scan rate was 0.1 mV s⁻¹ unless specified. The electrochemical impedance spectroscopy (EIS) was performed on battery cells by Autolab PGSTAT 100 electrochemical work station equipped with an EIS module. The frequency range was from 1 MHz to 10 mHz. The amplitude was 5 mV. Each cell was allowed to relax for at least 4 hours in order to reach equilibrium before test.

Effects of Scaffold Morphology on Anode Material Performance

Anode slurries were prepared by mixing active material Si nanoparticles (65%) with conductive agents Super P (10%) or CNF (5%), and chitosanTPP binder gel (20%) in a ball mill operating at 400 rpm for 6 hours. The chitosanTPP binder was prepared by mixing 6 mg/mL sodium tripolyphosphate (TPP) solution into 2% Chitosan solution in 2:5 ratio (v/v). The anode was then frozen at −40° C. for 24 hours in polymer centrifuge tubes and then freeze dried at −80° C. under vacuum. The freeze-dried samples were then used as composite material to make electrodes. The obtained freeze-dried anode composite was moistened with water and hand milled using a glass rod to make a slurry like consistency. Then the slurry was cast on the copper foils using a glass rod and dried under vacuum. For the scaffold anode the amount of Si in the composite was increased to 65%. The Carbon Super P content was reduced to 10% while keeping the amount of CNF and binder the same at 5% and 20%, respectively.

A freeze drying method was used to introduce porous scaffold structure in the anode matrix because of its effectiveness in producing highly stable and elastic sponge like structure in biopolymers like chitosan. The freeze drying method can be conducted at low temperature as compared to spray drying and coating method, lending it the advantage of minimizing the risk of chemical, structural changes in the polymers and biopolymers that may result from high heat treatment.

Morphological and Structural Analysis

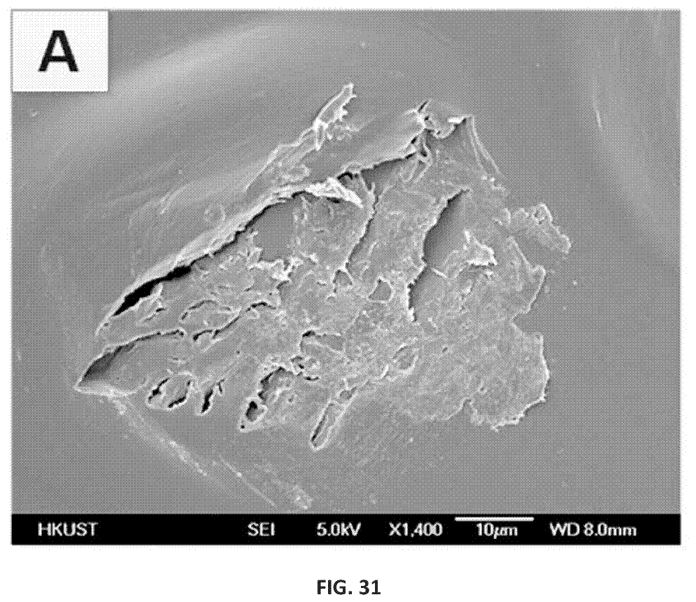

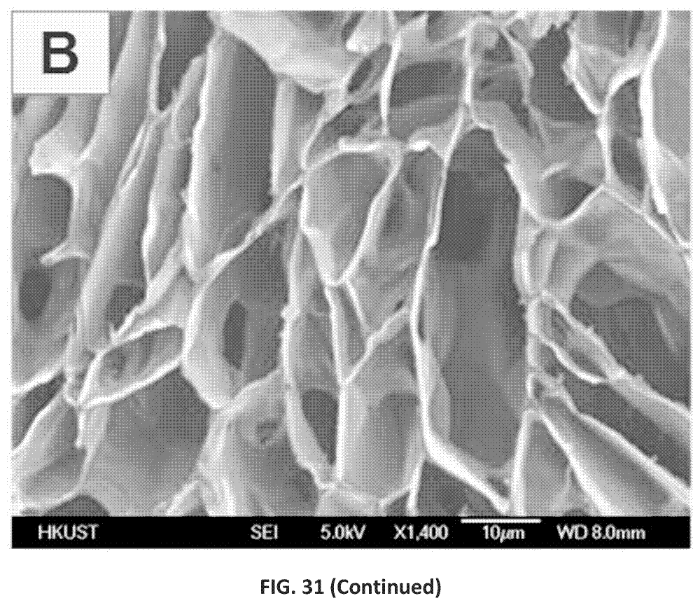

Soft 3D scaffolds including gels, hydrogels and sponges have high porosity with interconnected pores and large surface area. In solvent based phase separation, an immiscible solvent is added to a polymer solution for phase separation. FIG. 31 shows that normal chitosan gel and the porous chitosan scaffold. The resulting chitosan structure obtained by freeze drying is generally controlled by the solid-liquid phase separation of the chitosan molecules from the solution. Upon freezing of the aqueous chitosan-gel solution, an ice-solution interface forms and as the solution continues to cool, the ice-solution interface migrates normal to the freezing temperature front to increase the frozen area forming ice crystals between which chitosan resides. The phase separation technique is being used to produce scaffolds with different pore structure by varying the dependent parameters such as polymer concentration and phase separation temperature.

FIG. 31B shows the chitosanTPP scaffold having a porous structure with numerous folds which results in soft and spongy material. This morphology is formed due to the sublimation of the ice crystals from the frozen chitosanTPP gel. This similar technique was applied to produce scaffold anode composite for Silicon anodes using chitosan as binder.

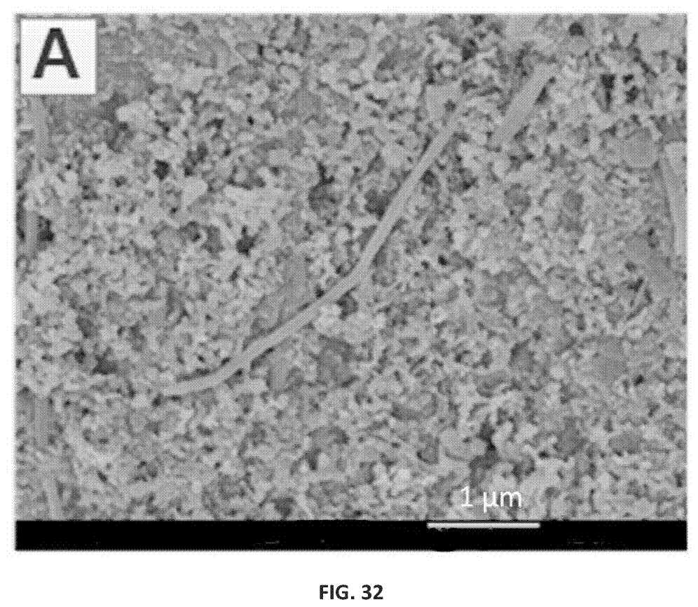

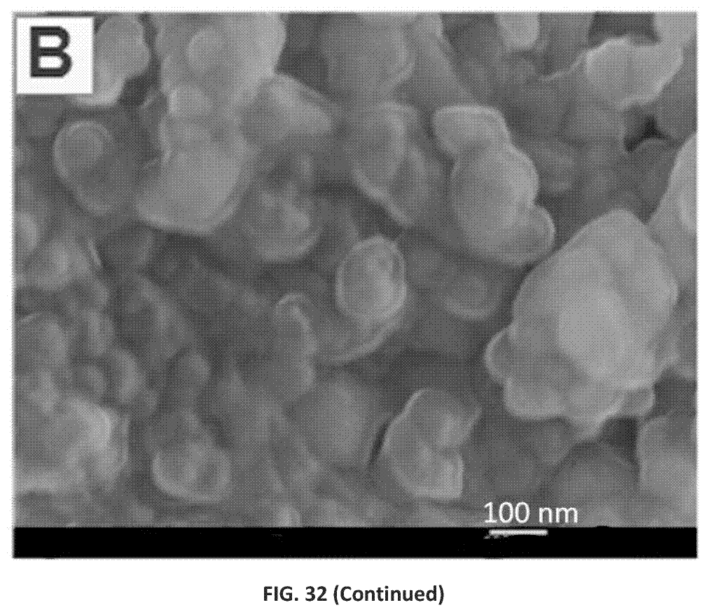

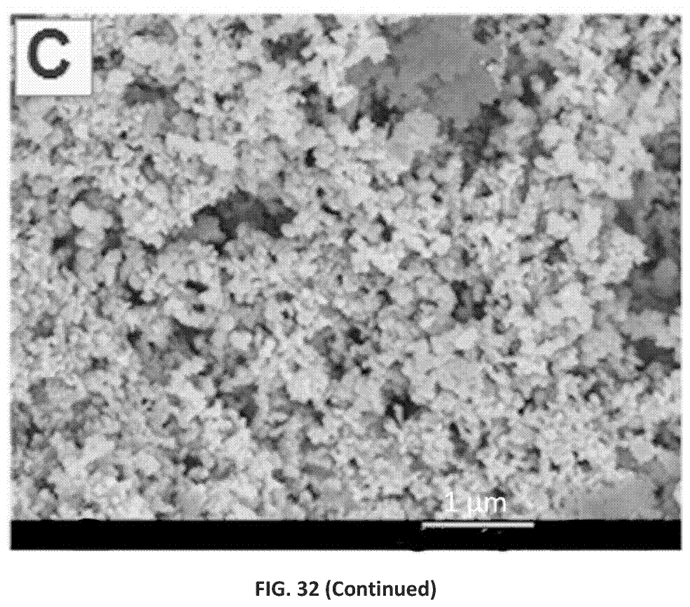

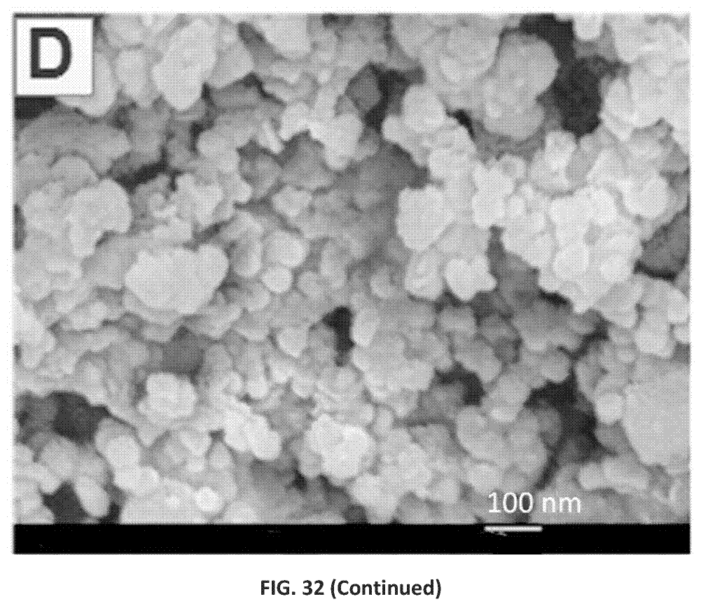

The morphologies of the original Si—C-CNF-chitosanTPP anode and that of its saffold variant are shown in FIG. 32.

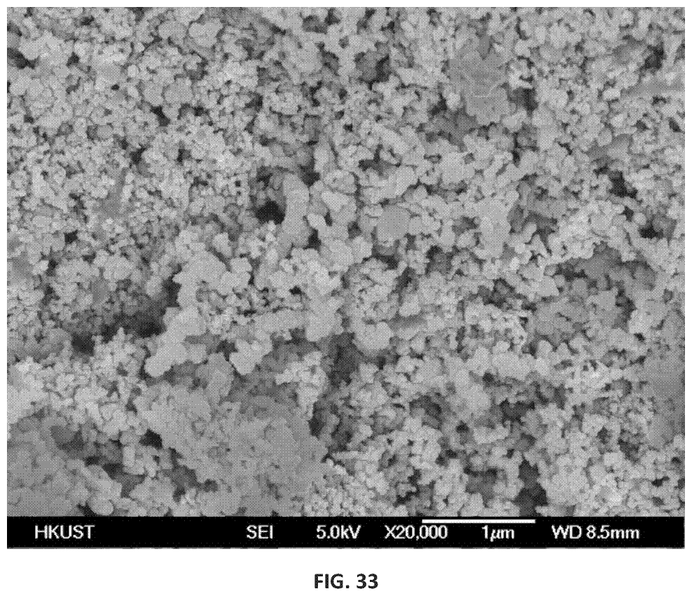

FIG. 32A shows the morphology of the original Si—C-CNF-chitosanTPP anode where one can see a generally porous structure in which the Si and C nanoparticles are bound with the chitosanTPP gel with CNF fibers around them. FIG. 32B shows a highly magnified SEM image of the composite where one can see the Si and C nanop articles coated with chitosanTPP binder. FIG. 32C shows the Si—C-CNF-chitosanTPP scaffold anode with a highly porous structure. The pores can help in the fast diffusion of the Li⁺ ions during charging and their extraction during discharging as they can reach the Si nanoparticles deep into the composite and alloy/dealloy with them. Moreover since the chitosan gel transforms into flexible and strong scaffolds, they can accommodate the volume expansion and contraction more efficiently during cycling and maintain the integrity of the composite structure. FIG. 32D shows a highly magnified SEM image of the scaffold composite. It is in contrast with FIG. 33C with the thick gel structure being absent from the scaffold composite.

In order to quantify the increase in porosity as a result of freeze drying, nitrogen adsorption measurements were performed on both the Si—C-CNF-chitosanTPP anode and the Si—C-CNF-chitosanTPP scaffold anode to obtain their specific surface area, average pore size, and pore size distribution. The results are listed in Table 5.

TABLE 5
Surface area, mean pore diameter and total pore volume of Si—C-CNF-
chitosanTPP anode and Si—C-CNF-chitosanTPP scaffold anode.

| | Surface area | Mean pore diameter | Total pore volume |
|---|---|---|---|
| Composite | (m²/g) | (nm) | (cm³/g) |
| Conventional | 7.48 | 64.3 | 0.111 |
| Scaffold | 28.04 | 34.6 | 0.216 |

The scaffold anode had both higher specific surface area and higher pore volume. Higher surface area means more accessibility of Li ions to the Si nanoparticles. And more pore volume helps accommodate the expansion of the Si nanoparticles during charging.

FIG. 33 shows the morphology of the Si—C-CNF-chitosanTPP anode after 500 cycles of charging and discharging. There are no appreciable changes in comparison with that of freshly made one, as shown in FIG. 32C, even after 500 times of cycling. This excellent structure stability should give good capacity retention of the Si anode, which is indeed the case as seen subsequently.

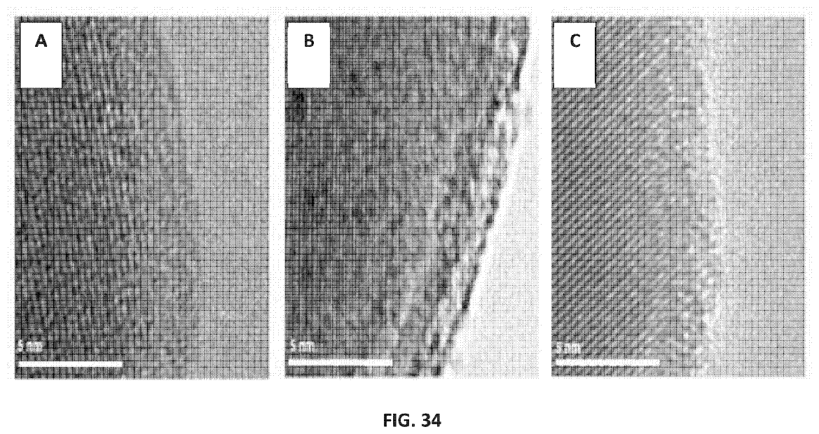

On careful inspection of TEM images of Si nanoparticles taken after 10, 100 and 500 cycles, as shown in FIG. 34, it can be found that the thickness of the SEI layer does not increase appreciably over cycling. After 10 cycles the SEI layer is about 2.5 nm containing SiO_{X} and electrolyte decomposition products. After 100 cycles the SEI layer thickness increases to about 3.5 nm due to formation of more SEI components on the anode during cycling. After 500 cycles there is insignificant increase in the SEI layer thickness, showing a rather stable anode under continuous cycling. This shows that chitosanTPP acts as perfect binder in covering the Si surface and thus forming a very stable SEI layer.

FTIR spectroscopy study was performed to determine the chemical bonds present in the anode composites. FIG. 35 shows the FTIR spectra of the Si—C-CNF-chitosanTPP anode and the Si—C-CNF-chitosanTPP scaffold anode. The Si—C-CNF-chitosanTPP scaffold anode shows all the vibrations related to the pyranose ring deformation and the phosphate interaction, as is found in the Si—C-CNF-chitosanTPP anode. This proves that freeze drying to form scaffolds does not alter the binding properties of the chitosanTPP binder.

Electrochemical Performance

Coin cells were assembled and cycled at 0.1C between 0.01-1 V for both Si—C-CNF-chitosanTPP anode and Si—C-CNF-chitosanTPP scaffold anode. Three replicate coin cells were tested for each composite.

Owing to its higher Si content, the gravimetric capacity of the Si—C-CNF-chitosanTPP scaffold anode was higher than the Si—C-CNF-chitosanTPP anode. As for the volumetric capacity, the Si—C-CNF-chitosanTPP scaffold anode had a markedly low capacity compared to the Si—C-CNF-chitosanTPP anode owing to the volume expansion of the scaffold anode composite because of the formation of numerous pores inside its matrix structure during freeze drying.

TABLE 6
Summary of active material loading, gravimetric and volumetric
capacities of the prepared anode composites.

| | Active material | Gravimetric | Volumetric |
|---|---|---|---|
| | loading | Capacity | Capacity |
| Composite | mg/cm² | mAh/g | mAh/cm³ |
| Si—C-CNF-chitosanTPP | 0.319 | 2088 | 3878.46 |
| Si—C-CNF-chitosanTPP | 0.317 | 2300 | 2285.63 |
| scaffold | | | |

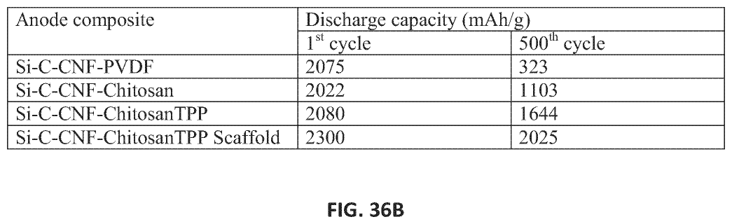

FIG. 36 shows that the scaffold anode performs the best in comparison to Si—C-CNF-chitosanTPP, Si—C-CNF-chitosan and Si—C-CNF-PVDF anodes, when the anodes are cycled at 0.1C rate. The initial discharge capacity of Si—C-CNF-chitosanTPP, Si—C-CNF-chitosan and Si—C-CNF-PVDF anodes were found out to be 2080 mAh/g, 2022 mAh/g and 2015 mAh/g, respectively, which was lower than that of the Si—C-CNF-chitosanTPP scaffold anode, owing to its higher Si content. A trend of rapid decrease in discharge capacity was observed till about 85-100 cycles for all the anode composites. According to previous research, this rapid decease in capacity in the initial cycles corresponds to the formation of the SEI layer on the Si nanoparticles during the initial charge-discharge cycles. After 100 cycles the Si—C-CNF-chitosanTPP scaffold, Si—C-CNF-chitosanTPP and Si—C-CNF-chitosan anodes retained 91%, 90% and 78% of its initial discharge capacities, respectively, while the Si—C-CNF-PVDF anode retained only 48% of its initial discharge capacity. After 500 cycles the Si—C-CNF-chitosanTPP scaffold, Si—C-CNF-chitosanTPP and Si—C-CNF-chitosan anodes retained 88%, 79% and 54% of its initial discharge capacities, respectively. The superior performance of the scaffold anode over large number of cycles can be attributed to its porous elastic structure, while retaining the excellent binding properties of the chitosanTPP binder. The freeze drying introduces cavities (pores) that allow the Si particles to expand with little deformation of the electrode structure so that the cycle stability of the Si electrode can be greatly improved. Moreover, the scaffold structure can also enhance the rate capability, because the porous structure increases ion transport in electrodes and accelerates the charge transfer reaction kinetics by the enhanced surface area.

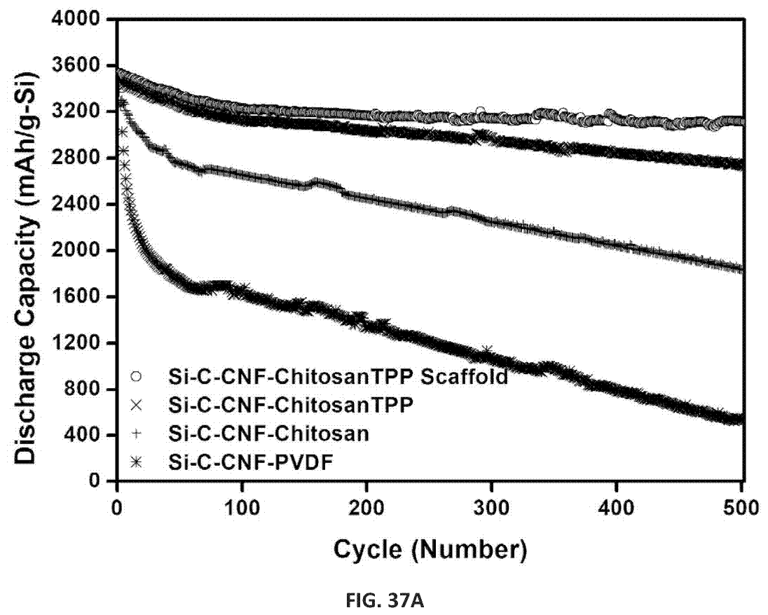

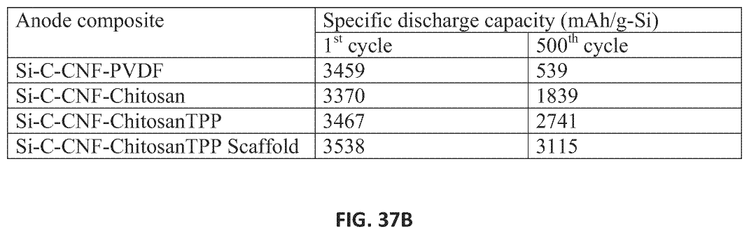

The specific discharge capacities of the prepared anodes were calculated, based on the Silicon content in the composite, as shown in FIG. 37. All the anodes have almost similar 1^{st} cycle discharge around 3400-3500 mAh/g, being quite short of achieving the theoretical discharge capacity of 4200 mAh/g. After 500 cycles the specific discharge capacities of the Si—C-CNF-chitosanTPP scaffold, Si—C-CNF-chitosanTPP, Si—C-CNF-chitosan and Si—C-CNF-PVDF anodes were 3115, 2741, 1839 and 540 mAh/g, respectively. This gives a clear indication of the ineffective binding power of PVDF compared to chitosan based binders. PVDF cannot prevent the anode from breaking down due to inherent drawbacks of Si as anode active material, by failing to solve the issues of pulverisation, delamination and SEI layer formation during cycling, resulting is dismal performance of Si based anode.

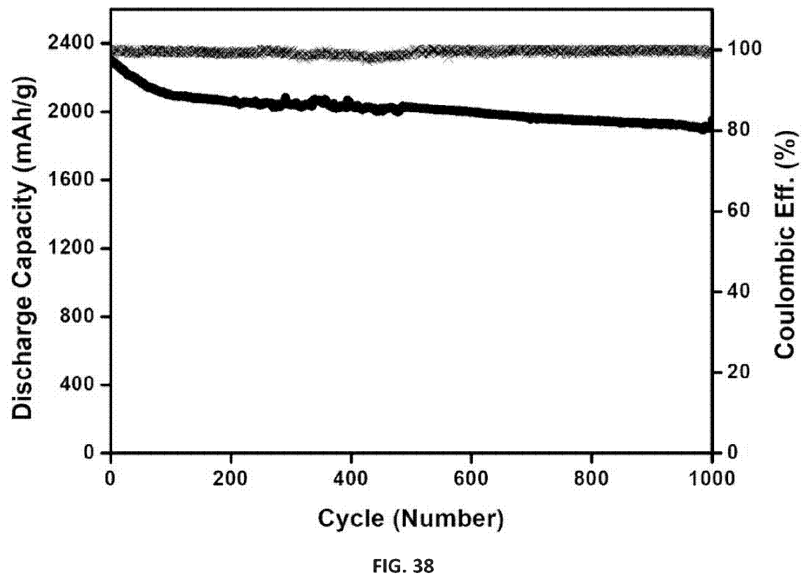

FIG. 38 shows the cycling performance of the Si—C-CNF-chitosanTPP scaffold anode over 1000 cycles. The 1^{st} cycle discharge capacity is 2300 mAh/g and coulombic efficiency is 99%. The discharge capacity shows very little decline over the whole process of 1000 cycles. After 1000 cycles the discharge capacity is still about 1950 mAh/g, corresponding to a capacity retention of about 85%. As discussed earlier, the highly porous structure of the freeze-dried anode helps in easy diffusion of the Li ions into the anode matrix and the large pore volume helps in mitigating the swelling and stress caused in the anode while cycling.

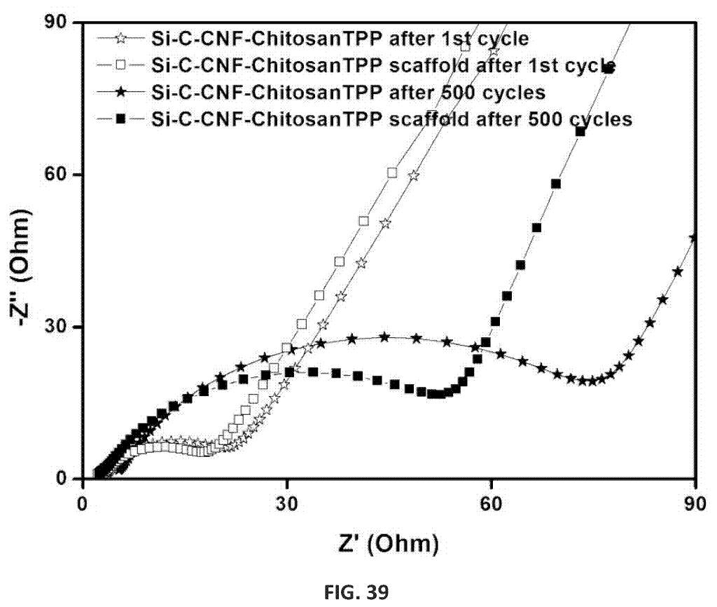

In order to further understand the charge transfer and Li ion diffusion behaviour inside the scaffold anode structure, electrochemical impedance spectroscopy (EIS) measurements were conducted after 1^{st} and 500^{th} discharge cycles. The Nyquist plots of the EIS measurements, done for both Si—C-chitosanTPP-CNF scaffold and Si—C-chitosanTPP-CNF anodes, as shown in FIG. 39, are composed of two overlapped semicircles in the high- and medium frequency regions and a straight line of Warburg impedance in the low-frequency region.

The Nyquist plots after 1^{st} cycle shows that both the anodes similar charge transfer resistance (R_{ct}) at the initial stage. After 500 cycles, the R_{ct} of the Si—C-chitosanTPP-CNF anode was found to be relatively higher (74Ω) compared to that of the Si—C-chitosanTPP-CNF scaffold anode (54Ω), however both the values are significantly less than R_{ct} reported by scientists previously for Si based anodes using PVDF or other polymeric binders. Low R_{ct} after 500 cycles indicates that the conductivity and the mechanical integrity of the electrode is maintained without polarization by maintaining the contact between the Silicon and conducting agents and providing a robust matrix structure which helps in maintaining the integrity of the anode. Lower R_{ct} for Si—C-chitosanTPP-CNF scaffold anode compared to that of Si—C-chitosanTPP-CNF anode, after 500 cycles shows that the Li-ion transport inside the scaffold structure is more fluid because of the nanocavities which aid in providing a clear passage to the Li-ions to move and bond with the Si nanoparticles.

What is claimed:

1. A binder for a battery electrode, the binder comprising chitosan and at least one phosphate salt or a conjugate acid thereof, wherein the at least one phosphate salt is selected from the group consisting of orthophosphate metal salts, pyrophosphate metal salts, and polyphosphate metal salts.

2. The binder of claim 1, wherein the at least one phosphate salt and chitosan are present in a 1:1 to 1:100 mass ratio.

3. The binder of claim 1, wherein the at least one phosphate salt is sodium tripolyphosphate.

4. The binder of claim 3, wherein the sodium tripolyphosphate and chitosan are present in a 1:5 to 1:10 mass ratio.

5. A binder composition for a battery electrode, the binder composition comprising the binder of claim 1 and a solvent.

6. The binder composition of claim 5, wherein the solvent is an aqueous solvent, a polar organic solvent, or a mixture thereof.

7. The binder composition of claim 6, wherein the solid content of the binder composition is 1% wt/wt or greater.

8. The binder composition of claim 5, further comprising at least one conducting additive and at least one anode active material; or at least one conducting additive and at least one cathode active material.

9. A lithium battery comprising: a positive electrode; a negative electrode disposed opposite to the positive electrode; and an electrolyte disposed between the positive electrode and the negative electrode, wherein at least one of the positive electrode and the negative electrode comprises the binder of claim 1.

10. The lithium battery of claim 9, wherein the negative electrode comprises the binder of claim 1 and the negative electrode further comprises at least one conducting additive and at least one anode active material.

11. The lithium battery of claim 10, wherein the at least one conducting additive is selected from the group consisting of carbon fiber, carbon nanofiber, carbon nanotubes, graphite, carbon black, graphene, and graphene oxide.

12. The lithium battery of claim 10, wherein the at least one anode active material is selected from the group consisting of silicon and silicon oxide.

13. The lithium battery of claim 9, wherein the positive electrode comprises the binder of claim 1 and the positive electrode further comprises at least one conducting additive and at least one cathode active material.

14. The lithium battery of claim 10, wherein the at least one phosphate salt is sodium tripolyphosphate, wherein the sodium tripolyphosphate and chitosan are present in a 1:7 to 1:10 mass ratio; the at least one conducting additive is selected from the group consisting of carbon fiber and carbon nanofiber; and the at least one anode active material is selected from the group consisting of silicon and silicon oxide.

15. A method for preparing the binder composition of claim 8, the method comprising: contacting chitosan; at least one phosphate salt selected from the group consisting of orthophosphate metal salts, pyrophosphate metal salts, and polyphosphate metal salts; at least one anode active material or at least one cathode active material; and a solvent thereby forming the binder composition of claim 8.

16. The method of claim 15, wherein the solvent is water comprising an organic acid.

17. The method of claim 16, further comprising the step of removing the solvent by freeze drying thereby forming the binder composition of claim 8.

18. A binder composition prepared according to the method of claim 17.

19. The binder composition of claim 18, wherein the at least one phosphate salt is sodium tripolyphosphate, wherein the sodium tripolyphosphate and chitosan are present in a 1:7 to 1:10 mass ratio; the at least one conducting additive is selected from the group consisting of carbon fiber and carbon nanofiber; and the at least one anode active material is selected from the group consisting of silicon and silicon oxide.

20. A lithium battery comprising: a positive electrode; a negative electrode disposed opposite to the positive electrode; and an electrolyte disposed between the positive electrode and the negative electrode, wherein at least one of the positive electrode and the negative electrode comprises the binder composition of claim 19.
